(19) United States
(12) Patent Application Publication
(10) Pub. No.: US 2016/0246777 A1
(43) Pub. Date: Aug. 25, 2016

(54) SYSTEM AND METHOD FOR PROVIDING A COMMUNICATION PLATFORM WITH GUIDED DIALOGICAL FUNCTIONS

(71) Applicant: Mihnea Calin MOLDOVEANU, Toronto (CA)

(72) Inventor: MIHNEA CALIN MOLDOVEANU, TORONTO (CA)

(21) Appl. No.: 15/023,025

(22) PCT Filed: Sep. 18, 2014
(86) PCT No.: PCT/CA2014/000696

§ 371 Date: Mar. 18, 2016

Related U.S. Application Data
(60) Provisional application No. 61/879,414, filed on Sep. 18, 2013.

(51) Int. Cl. G06F 17/27; H04L 12/58; H04L 29/06

(52) U.S. Cl. CPC G06F 17/279; G06F 17/273; H04L 65/403; H04L 51/046

(57) ABSTRACT

A system and method for guiding communication by users engaging in dialogue are provided. At least part of a dialogue is received from a user. The received part of the dialogue is analyzed to produce content analysis data. At least one discourse rule is selected from a plurality of discourse rules. The selected at least one discourse rules is applied to the content analysis data, and at least one suggestion to a user engaging in the dialogue is generated. Utilizing the at least one suggestion by the user promotes, in an automated fashion, the use of validated dialogical strategies in the dialogue.

### FIELD OF INVENTION

The present invention relates to social communication platforms and content engagement platforms. The present invention also relates to e-learning platforms.

### BACKGROUND

Dialogical skills and structures are used to engage in an effective exchange of opinions on a particular topic between two or more people. Structured dialogue includes posing and answering questions, asking for and giving clarifications, and raising and responding to challenges.

Development of effective dialogical skills is an important aspect of acquiring effective communication skills generally. Communication skills are required to operate effectively in real life and virtual environments. Dialogical skills are useful in virtually any set of communications involving two or more persons seeking to explain a point effectively, advance a position, or challenge another position.

Electronic communications and social media interactions have become prevalent. However, communication over social media is often disorganized and poorly structured. In a typical case, various users simply state their position without defending it, answering questions about it, or clarifying what they mean by various words.

Dialogical training, namely, training in communicating in a structured, disciplined and coherent fashion in person or over social media, is often not readily available to or easily accessible. The need for greater dialogical training is evident in the generally inferior quality of electronic communications from a dialogical perspective.

There is tremendous interest in promoting engagement between users through a variety of platforms including social networking platforms. The low quality of communications in a social networking platform, for example, may be an obstacle to encouraging engagement, including those who may have the most to contribute to a social conversation, for example.

Also, while in some cultures dialogical techniques are inherent to social communications and therefore are learned and used extensively, these techniques may be contrary to social norms in other cultures. In cultures where the latter is the case, there is a particularly great need for scalable platforms and techniques for development of dialogical skills.

There is a need for a platform and set of tools and techniques that provide effective and convenient way for users to enter into structured and disciplined dialogues, and to access dialogical training. There is a further need for a communication platform that integrates these tools and technique in every day electronic communications.

### SUMMARY

In one aspect of the invention, there is provided a system for guiding communication by users engaging in dialogue. The system includes one or more computers executing a server application that provides: a semantic analyzer component configured to analyze at least part of a dialogue to produce content analysis data, and a communication facilitator component configured to select at least one discourse rule from a plurality of discourse rules; apply the selected at least one discourse rule to the content analysis data, and provide at least one suggestion to a user engaging in the dialogue; wherein the user utilizes the at least one suggestion by selecting or adapting a statement based on the at least one suggestion, and wherein utilizing the at least one suggestion promotes, in an automated fashion, the use of validated dialogical strategies in the dialogue.

In another aspect of the invention, there is provided a computer-implemented method for guiding communication by users engaging in dialogue. The method includes receiving, at at least one processor, at least part of a dialogue from a user, analyzing, at the at least one processor, the received part of the dialogue to produce content analysis data, selecting, at the at least one processor, at least one discourse rule from a plurality of discourse rules stored in an electronic datastore; applying, at the least one processor, the selected at least one discourse rule to the content analysis data, and generating, at the least one processor, at least one suggestion to a user engaging in the dialogue.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagram of a communication platform, exemplary of an embodiment.

FIG. 2 is a schematic diagram of a computing device that may be used to implement the platform of FIG. 1, exemplary of an embodiment.

FIG. 3 illustrates a state x input dependent, Finite State Machine representation of the platform of FIG. 1, exemplary of an embodiment.

FIG. 4 illustrates a specific instantiation of the state x input dependent state transition logical flow path of the semantic management system of the platform of FIG. 1, based on a 2-user protocol, exemplary of an embodiment.

FIG. 5 illustrates exemplary high-level mapping of user inputs and states onto the specific variables of the platform of FIG. 1, exemplary of an embodiment.

FIG. 6 illustrates example guided dialogical processes implemented by the platform of FIG. 1, exemplary of an embodiment.

FIG. 7 illustrates the basic set of moves that the platform of FIG. 1 allows each user to make, as a function of the current state of the dialogue, exemplary of an embodiment.

FIG. 8 illustrates an example screen showing the dialogue mapping/display Function of the platform of FIG. 1, exemplary of an embodiment.

FIG. 9 is a schematic diagram of the evaluative scoring function of the platform of FIG. 1, exemplary of an embodiment.

FIG. 10 is a schematic diagram showing an example of the use of the scoring system of the platform of FIG. 1, the example including a high-score question and answer, exemplary of an embodiment.

FIG. 11 is a schematic diagram showing an example of the use of the scoring system of the platform of FIG. 1, the example including a high-score question and a low-score answer, exemplary of an embodiment.

FIG. 12 is a schematic diagram showing calculation of user scores by the platform of FIG. 11, exemplary of an embodiment.

FIG. 13 illustrates an example screen showing the evaluative/scoring function of the platform of FIG. 1, exemplary of an embodiment.

FIG. 14 shows an example data structure used by the platform of FIG. 1 to store arguments made by different users as a function of moves made by other users in the arguments, exemplary of an embodiment.

FIG. 15 illustrates an example screen showing various components of the platform of FIG. 1 used in a multi-user training environment, exemplary of an embodiment.

FIG. 16 illustrates an example screen showing the communication tutoring function of the platform of FIG. 1, exemplary of an embodiment.

FIG. 17 is a schematic diagram showing the use of the platform of FIG. 1 in a self-training/practice mode, exemplary of an embodiment.

FIG. 18 is a schematic diagram showing the use of the platform of FIG. 1 in an instructor-assisted single-user training/practice mode, exemplary of an embodiment.

FIG. 19 is a schematic diagram showing the use of the platform of FIG. 1 in an instructor-supervised self-training/practice mode, exemplary of an embodiment.

FIG. 20 is a schematic diagram showing the use of the platform of FIG. 1 in a multi-user gaming mode, exemplary of an embodiment.

FIG. 21 is a schematic diagram showing the use of the platform of FIG. 1 in a supervised multi-user gaming mode, exemplary of an embodiment.

FIG. 22 is a schematic diagram showing the use of the platform of FIG. 1 in a self-guided critical reading mode, exemplary of an embodiment.

FIG. 23 is a schematic diagram showing the use of the platform of FIG. 1 in a self-guided critical thinking mode, exemplary of an embodiment.

FIG. 24 illustrates the statement classification function of the platform of FIG. 1, exemplary of an embodiment.

FIGS. 25-30 each illustrates example questions and answers relating to descriptive particular statements.

FIGS. 31-43 each illustrates example questions and answers relating to descriptive general statements.

FIGS. 44-56 each illustrates example questions and answers relating to normative statements.

FIG. 57 illustrates example types of challenges.

FIG. 58 is a schematic diagram of the structure of interactions between a user (respondent) and a challenger provided by the platform of FIG. 1, exemplary of an embodiment.

FIGS. 59-65 each illustrate an example challenge to a statement.

FIGS. 66-70 each illustrate an example response to a challenge.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

In one aspect of the invention, a communication platform is provided that facilitates electronic communications between users engaged in a dialogue that is guided by a computer system. “Dialogue” means the exchange of opinions regarding a particular topic, between two or more users. The computer system executes a series of logical functions that teach and promote the use of dialogical skills for engaging in dialogue via electronic communication networks.

As detailed below, the communication platform disclosed herein includes a semantic analyzer component that analyzes statements to produce content analysis data, and a communication facilitator component that (i) accesses a set of discourse rules; (ii) applies the discourse rules to the content analysis data, and based on this (iii) produces one or more suggestions to a first user to advance discourse through the platform with another user. The discourse rules are related to application of dialogical skills in electronic or social conversations.

Users of the communication platform may be organized into two main groups depending on their current role relative to an active conversation guided by the platform: (i) proponents are advancing a statement, regarding a particular topic or the statement may be itself a topic for discussion; and (ii) opponents (questioners and challengers) are participating in an active conversation with the proponent(s), and their role is to respond to the statement in some way, for example, by asking for clarification or justification, or by challenging the statement. As detailed below, other users may include administrators and teachers.

The communication facilitator component (i) analyzes the statement, and (ii) based on such analysis makes suggestions to the proponent(s) that promote the learning of dialogical skills and/or promote the application of dialogical skills to the active conversation. In one aspect, the communication facilitator component generates one or more suggestions for the proponent(s) and/or the opponent(s), for use in adapting their statement.

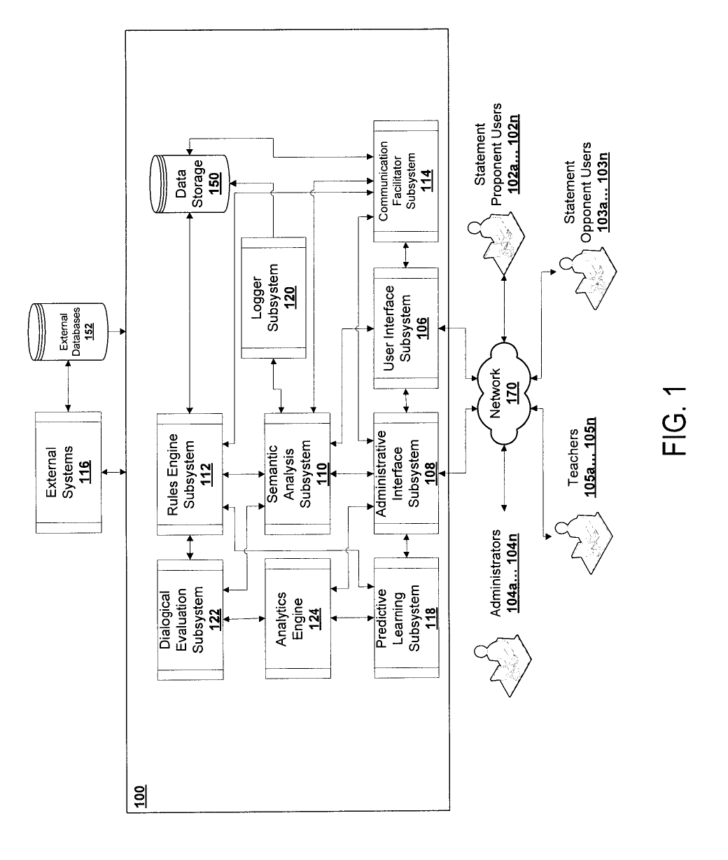

FIG. 1 is a block schematic diagram of a communication platform (100), exemplary of an embodiment. While the block schematic diagram illustrates a number of subsystems and components, the schematic is an example and there may be more, less, different and/or variations of these subsystems and components.

In the embodiment depicted in FIG. 1, the communication platform (100) includes one or more subsystems, such as a user interface subsystem (106), an administrative interface subsystem (108), a semantic analysis subsystem (110), a rules engine subsystem (112), a communication facilitator subsystem (114), a predictive learning subsystem (118), a logger subsystem (120), a dialogical evaluation subsystem (122), an analytics engine (124), and data storage (150).

The communication platform (100) may also be configured to communicate or otherwise interact with external systems (116), which may be associated with external databases (152). These communications and/or interactions may be provided through, for example, one or more suitably configured interfaces, and may support various functionality, such as the derivation of rules and/or logic from sources external to the communication platform (100). The external systems (116) may include various suitably configured external systems, such as social media networks, databases having dialogical rules, etc.

In some embodiments, the communication platform (100) may be configured to interface with external systems (116) to provide a layer that provides functionality that interacts with the dialogical functionality of the external systems (116). For example, the communication platform (100) may be configured to receive information from dialogical statements within a particular external system (116), such as a tweet, an instant message, a posting, and conduct an analysis of such statements. Various components of the communication platform (100) may then be adapted for use with the external systems (116); for example, the user interface subsystem (106) being adapted for displaying outputs alongside displayed text from a social media platform (e.g. the user's proposed tweet responding to a statement has a low dialogical score as the response has poor relevance to the original statement).

So, the communication platform (100) may be configured to enhance or supplement an external system (116) (e.g., a social media platform or website) by providing at least some of the dialogical functionality disclosed herein (e.g., scoring, providing suggestions for responding to statements, etc.) in those external systems (116). For example, the various interfaces of communication platform (100) may be presented as an overlay or be otherwise integrated into the interfaces provided by the external systems (116). Further, aspects of communication platform (100) may be configured as a plugin that for ready integration with such external systems (116), or expose an Application Programming Interface (API) allowing functionality of the platform (100) to be accessed by such external systems (116).

In some embodiments, the communication platform (100) may be configured to receive a set of rules from an external system (116) that may be used to suitably configure the rules engine (112). In some embodiments, the communication platform (100) may be configured to transmit and/or receive information regarding other implementations of dialogical communications/e-learning such that the additional information may be utilized across various systems, for various reasons, such as increasing the robustness of analytics and/or engaging in predictive learning.

In some embodiments, the communication platform (100) is implemented using a variety of electronic and/or computerized technologies, and the description provided may describe how one would modify a computer to implement the system or steps of a method. The specific problem being solved may be in the context of a computer-related problem, and the system may not be meant to be performed solely through manual means or as a series of manual steps. The communication platform (100) and its components may be implemented using various equipment, such as a server, having one or more processors and one or more non-transitory computer readable media. The communication platform (100) and its components may be also implemented on various distributed networking technologies, such as cloud computing resources, etc.

Computer-related implementation and/or solutions may be advantageous in the context of some embodiments; at least for the reasons of providing scalability (the use of a single platform/system to manage a large number of activities); the ability to quickly and effectively pull together information from disparate networks; the ability to apply complex dialogical rules that would be impracticable using manual means; the ability to dynamically develop intelligent responses; the ability to interact with external systems whose interactions must be through electronic means; and/or the ability to conduct analytics that would otherwise be unfeasible.

Scalability may be useful as it may be advantageous to provide a communication platform that may be able to effectively manage a large number of inputs, each being processed based on a complex set of dialogical rules.

The communication platform (100) may be configured to support a variety of guided dialogical functions, among other functionality, which may be used, for example, for e-learning platforms involving structured dialogue.

The communication platform (100) may be used by one or more statement proponent users (102a . . . 102n), one or more statement opponent users (103a . . . 103n), one or more administrators (104a . . . 104n) and/or one or more teachers (105a . . . 105n). As noted, users of the communication platform (100) may be organized into two groups depending on their current role relative to an active conversation guided by the platform: (A) proponents are advancing a statement, regarding a particular topic or the statement may be itself a topic for discussion; and (B) opponents (questioners and challengers) are participating in an active conversation with the proponent(s), and their role is to respond to the statement in some way, for example, by asking for clarification or justification, or by challenging the statement.

The one or more teachers (105a . . . 105n) may use the communication platform (100) in various capacities, for example, as observers, supervisors, conversation facilitators, scorers, etc. Teachers (105a . . . 105n) or other users using the platform (100) as observers may observe interactions in real-time, or by playback of stored records. The one or more teachers (105a . . . 105n) may various capabilities in interacting with the communication platform (100) and/or various administrative functionalities with the communication platform (100). For example, a teacher may be able to observe a dialogue session between a statement proponent user (102a . . . 102n) and a statement opponent user (103a . . . 103n), and provide scoring based on the teacher's assessment of the strength of the statements adduced by each user. Further, in some embodiments, the teacher may be able to access some administrative functionality, such as the modification of rules, the viewing of analytical reports, etc.

Administrators and teachers may also be users, and vice versa. Teachers may also be administrators, and vice versa.

During the course of a conversation, or multiple conversations, the roles of opponents and proponents may be held by the same or different users. For example, a user may select to be both the opponent and a proponent, making arguments on taking various positions in respect of an active conversation. The administrators may conduct various administrative tasks in facilitating conversation and/or otherwise administering the system, such as dividing out users into groups, creating dialogical pathways, defining dialogical rules, refining recommendations, etc.

These users and/or administrators may communicate with the communication platform (100) through one or more networks (170). The network (170) may include the Internet, intranets, point-to-point networks, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Networking technology may include technologies such as TCP/IP, UDP, WAP, etc.

The user interface subsystem (106) may be configured to provide various input/output/display functionality for interaction with various users (e.g. statement proponent users and statement opponent users). The user interface subsystem (106) may be used to support various types of dialogical interaction, such as providing functionality for guiding or otherwise enabling a structured discourse. The inputs may be received from manual entry, importation from various other systems or websites, the importation of information from other electronic documents, electronic databases, etc. For example, the information could be provided as instant messages, Microsoft Word™ documents, text files, portable document format files (PDF), comma-separated values (CSV), Microsoft Excel™ documents, extensible markup language (XML), hypertext markup language (HTML) or scanned physical documents.

In some embodiments, the inputs to the user interface subsystem (106) may be retrieved and/or otherwise communicated from external systems (116), such as instant messages, emails, tweets, postings, comments, etc. The user interface subsystem (106) may further be configured to overlay recommendations and various interface elements directly on to the display of various external systems (116), and options for responding, etc., may also be configured to interact with the input capabilities of the external systems (116).

These various inputs may be processed by the semantic analysis subsystem (110) and various statements, information, etc., may be extracted for use by the communication platform (100).

As noted, aspects of platform (100) may be configured as a plugin for integration with external systems such as, e.g., external systems (116). In an embodiment, platform (100) may include a component configured as a plugin (extension) for a web browser (e.g., Google Chrome, Microsoft Internet Explorer, Mozilla Firefox, or the like). This plugin may be installed in association with such a web browser on a computing device operated by a user (or a teacher or administrator). In such circumstance, the plugin may present one or more buttons (or other user-interface elements) in the web browser that allow a user to access the functionality of platform (100) disclosed herein.

In one example, a user may select a portion of a webpage (e.g., by highlighting it) and then click on a button provided by the plugin to submit the selected portion as an input to platform (100). In this way, the user may initiate a dialogue in relation to the selected portion, or store the selected portion for a later dialogue. The user may then engage in a dialogue through platform (100) with other users (e.g., particular selected users, or users in a pre-defined group, as described below, or possibly all other users who are logged in). In this way, users may conveniently engage in dialogues guided by platform (100) in relation to any webpage or portions thereof. Responses (e.g, questions, queries, challenges, answers) may be received from platform (100) in real-time. Responses and other outputs from platform (100) may be displayed by the plugin as an overlay on the webpage, or in a separate display of the web browser.

In other embodiments, the plugin may be configured for integration with another type of software, such as a word processor, a document viewer, an instant messaging software, or the like. The plugin may also be configured for integration with software used in particular settings (e.g., professional, business, medical, educational, etc.). In manners similar to that described above for a web browser, in these other types of software, a user may select a portion of text from a document or a message for submission to platform (100). In this way, a user may engage in dialogues guided by platform (100) on text from such documents or messages.

So, for example, users may engage in guided dialogues and interact in real-time with other users in relation to documents (e.g., patent applications, legal opinions, medical cases, business cases, etc.) that are being viewed or prepared. Through platform (100), users will be able to raise questions, queries, challenges, and provide answers in relation to such documents, all in real-time. In this way, users may be assisted as they consume or prepare such documents.

In an embodiment, the user interface subsystem (106) may be configured to provide interfaces allowing a user to define a “conversation group” comprising users with whom a dialogue will be engaged. Each user may define multiple groups of users. Each group may be associated with a particular topic, particular text, particular social media platform, or the like. Groups may be automatically imported from external systems (116), e.g., from address books, social media networks, friends lists, class lists, or the like. Records of groups defined in such manners may be stored at platform (100), e.g., in data storage 150, for later use. In one example, a user may input text and select one of the pre-defined groups for engaging in a dialogue in relation to the inputted text. In another example, when a user inputs text for engaging in a dialogue, the appropriate group may be automatically selected. In an embodiment, groups may be defined by teachers and/or administrators. For example, a teacher may define a group comprising students expected to engage in a particular exercise.

Various modes of interaction may be available, such as a self-training/practice mode, a competition mode, an instructional training (instructor-guided) mode, supervised modes, multi-user gaming modes, supervised gaming modes, self-guided critical reading modes, self-guided critical thinking modes, etc.

The user interface may be configured for displaying suggestions, allowing users to select discourse options, receiving various inputs from the users, displaying conversation details, displaying metadata associated with various conversations, etc. In some embodiments, conversations may be displayed in various structured forms, such as trees, linked lists, etc. For example, during interaction, the user interface subsystem (106) may be configured to display the entire history of the dialogue among two or more users in the form of a tree whose stem(s) represent one or more statements (the content) and whose roots represent queries and clarifications, questions and answers, and challenges and responses input by other users.

The user interface may also be configured to provide explanations and/or instructions related to structure dialogical interactions, such as explaining why a move is suggested, etc.

In some embodiments, the user interface subsystem (106) may be configured to provide sequential interactions between users who are connected in an active dialogue session, track conversational states, and update conversational states that transition the state of the communication platform (100) in the manner of a finite state machine, such that the states may be dependent jointly on (a) the last state of the machine, and (b) the input(s) of the user(s). The particular state of a conversation may guide various elements of the user interface subsystem (106) and how the elements are displayed to a user.

Depending on the particular state of the communication platform (100), different interface elements may be present. Accordingly, the interface may be configured for the implementation of various modes of operation and interactions, including the receiving and displaying of statements, queries, challenges, answers, questions, answers, suggestions, modified statements, etc. In some embodiments, interactions are guided from one move to the next and the user interface subsystem may display the current state of the dialogue, as provided by the communication platform (100) and a set of suggestions as offered by the communication platform (100) for the next move in the dialogue.

Various interface elements may be provided in response to other inputs or otherwise triggered by various parameters. For example, the user interface subsystem (106) may provide various options in response to inputs from another user, and may, for example, provide functionality for users to modify statements, select responses, review prior responses, assess prior arguments, etc.

The administrative interface subsystem (108) may be configured to provide various input/output/display functionality for one or more administrative users (104a . . . 104n). The administrative interface subsystem (108) may further be configured to support administrative functionality, such as the ability to define/apply rules, the ability to conduct various analysis and/or request reports, the ability to change one or more settings/parameters associated with dialogical training, the ability to change one or more settings associated with how information is displayed to the users, the ability to administer various account/profile related details, the ability to author content to be utilized by the communication platform (100), etc. For example, an administrator may restrict the number and identities of the users who may use the platform with respect to a piece of content.

In some embodiments, the administrative interface subsystem (108) may be accessed through or configured for interaction with an external system (116). For example, settings may be modified directly through various interfaces on a social media platform.

The semantic analysis subsystem (110) may be configured to receive information (e.g. raw dialogical statements) from the users and to extract and/or parse various information from the received information, in relation to structured dialogue. In some embodiments, the semantic analysis subsystem (110) may also append and/or modify various metadata tags associated with parsed information. For example, the semantic analysis subsystem (110) may provide a tag indicating that a particular portion of an input is part of a phrase, is a noun, is punctuation, is a verb, is a word that changes the meaning of a statement, starts a new clause, statement is a normative statement (e.g. contains “should”, “ought”, “must”), etc.

In some embodiments, the semantic analysis subsystem (110) may be configured to detect typographical mistakes and/or to attempt to infer what was meant by the user. For example, the semantic analysis subsystem (110) may be configured to provide a semantic layer that analyzes statements to produce content analysis data. The content analysis data may be utilized by the communication platform (100) for various activities and/or interactions. The semantic analysis subsystem (110) may be configured to apply different rules in semantically parsing a statement if a statement is, for example, a clarification statement, a querying statement, a challenging statement, etc., and also may apply different rules depending on the particular group of a user (e.g. proponent or opponent). The semantic analysis subsystem (110) may keep track of linkages between various statements, such as statements that refer to one another, are responsive to one another, etc. The various contexts and information known about a user and/or a dialogue may also be considered by the semantic analysis subsystem (110), such as the age, ethnicity, fluency in language, statement source (e.g. internet), educational level, cultural group, speech patterns, etc.

In some embodiments, the semantic analysis subsystem (110) may, for example, be able to discern between various statements, queries, clarifications, questions, answers, modifications, arguments, challenges, responses, etc., and also to discern between various subtypes of information, such as types of statements, types of challenges, etc.

The rules engine subsystem (112) may be configured for the generation, defining, modification, deletion and/or application of one or more logical rule sets. These one or more logical rule sets may be initially provided and may also be capable of adaptation and/or refinement over a period of time and taking into consideration historic interactions with the communication platform (100) from various users. The one or more logical rule sets may have various types of computer logic, for example, logic may be included that acts as triggers, that cause various actions to be performed by the communication platform (100), that modify parsed information in various ways, that may be utilized by the semantic analysis subsystem (110) to parse information, etc. The rules engine subsystem (112) may further contain one or more rules wherein various operational parameters (e.g. what state the dialogue is in), may define what logic is provided by the rules. The rules themselves may also be configured for adaptation and/or refinement as more interactions are amassed.

These rules, for example, may be used to create linkages between inputs from users, create linkages between parsed portions of inputs, conduct automated scoring, develop suggestions/recommendations, develop dialogical structure, cause various actions to occur, etc.

The communication facilitator subsystem (114) may be configured for providing various functionality to facilitate a communication between users, such as, providing recommendations, indicating graphically potential next steps, suggesting modifications to dialogical arguments, etc. The communication facilitator subsystem (114) may access a set of discourse rules from the rules engine subsystem (112), apply the discourse rules to the content analysis data as received from the semantic analysis subsystem (110), and based on this data, produces one or more suggestions to one or more users in a dialogue.

The one or more users may then, through the user interface subsystem (106), utilize the suggestions by selecting a statement based on a suggestion or adapting a statement using the suggestion.

The dialogical evaluation subsystem (122) may interact with both the rules engine subsystem (112) and the semantic analysis subsystem (110) to derive one or more scores based on the particular communication as provided by the semantic analysis subsystem (112). The scores may be based off of rule sets as held by the rules engine subsystem (112). For example, the communication facilitator subsystem (114) may be configured to access a set of discourse rules, apply the discourse rules to content analysis data, and based on this, and through interacting with the user interface subsystem (106), produce one or more suggestions to one or more proponents in the dialogue. The user interface subsystem (106) may then enable the one or more users to utilize the suggestions for example by selecting a statement based on a suggestion or adapting a statement using the suggestion. Other interactions with suggestions may also be provided.

In some embodiments, the dialogical evaluation subsystem (122) may be configured such that users may evaluate each other's contributions to the dialogue, and the dialogical evaluation subsystem (122) may be configured to facilitate such an interaction and/or to log the scores contributed by the users. In some embodiments, scoring may also be automated and/or semi-automated, based on rules from the rules engine subsystem (112). In some embodiments, one or more teachers (105a . . . 105n) may input scores to evaluate various dialogical interactions.

Various scores may be given and may be differentiated upon a number of different considerations, such as relevance, responsiveness, informative-ness, degree of support, etc., and the dialogical evaluation subsystem (122) may be also configured to provide aggregate scores, such as argumentation performance scores, game scores, performance evaluation scores, learner outcome measure scores, etc.

For example, based on scores that are input by users or instructors for statements, questions and answers, scores for entire arguments (chains of statements that are linked by inferential steps) can be computed by the dialogical evaluation subsystem (122) as the sum of the scores for the individual statements and answers to questions about statements.

The scores may then be used as either a developmental tool (to provide detailed feedback to participants on their dialogical skill) or as a selection/sorting system—to group users on the basis of their dialogical competence.

The analytics engine (124) may be configured to conduct various analyses and/or to generate various reports based on the stored information in data storage (150). In some embodiments, the analytics engine (124) is configured to record and track the structure and dynamics of dialogical moves performed by users.

For example, analysis may be conducted based on any type of information stored, such as the duration of time required for a user to respond to a type of argument, what the average score achieved by responses filed to a particular statement, score associated with the response, etc. The analytics engine (124) may pre-process and/or transform information/data prior to conducting analyses.

The predictive learning subsystem (118) may be configured for applying various approaches for predicting and/or refining interactions and/or logical rules associated with communication platform (100). The predictive learning subsystem (118) may be configured to utilize various machine learning and/or predictive algorithms, such as probabilistic models, fuzzy-learning techniques, various feedback loops, etc., that may be refined and/or adapted over the set of interactions with the communication platform (100). The insights that may be generated by the analytics engine (124) may be used to iteratively improve the relevance and responsiveness of suggestions generated by the platform.

The logger subsystem (120) may be configured to log and/or otherwise track parsed information from the semantic analysis subsystem (110) for recording into data storage (150). Such logged information, which may include additional information, such as metadata tags, may then be accessed or otherwise utilized by the communication platform (100). The structure of a dialogue, as well as any associated relationships and/or linkages between various statements and/or inputs may also be logged by the logger subsystem (120).

The data storage (150) may be configured to store, process, pre-process, various information associated with semantic analysis subsystem (110), such as raw information received from users through the user interface subsystem (106), states of operation of the communication platform (100), recommendations generated by the communication facilitator subsystem (114), parsed information from the semantic analysis subsystem (110), various logged information received from the logger subsystem (120), rule sets generated and/or for application by the rules engine subsystem (112), various information received from external databases (152) or external systems (116), scores generated by the dialogical evaluation subsystem (122), reports generated by the analytics engine (124), etc. The data storage (150) may also be configured to identify and/or maintain relationships between various elements of information stored thereon, and information may be stored as one or more records. In some embodiments, the data storage (150) may also be configured for various data warehousing functionality, such as data compression, extraction, transformation and loading.

The data storage (150), for example, may be used for the registering, tracking, organizing and scoring all of the dialogical games, interactions, conversations that have taken place, and may further be in a format that allows an administrator, to encode, research, evaluate and otherwise use the entire data set generated by the communication platform (100) to explore patterns of conversation, patterns of reasoning, patterns of inference, patterns of challenge and response, patterns of questions and queries, patterns of clarifications and answers, that users give to each other and to themselves as part of using the platform.

The resulting data can be used by the analytics engine (124) and the predictive learning subsystem (118) to develop predictive and explanatory models of patterns of reasoning, inference, querying, questioning, clarifying, answering, justifying, challenging and responding across cultural and ethnic boundaries, within and between professional and institutional domains, and within and between research and institutional domains.

The data storage (150) may be implemented as a conventional relational database such as a MySQL™, Microsoft™ SQL, Oracle™ database, or the like. The data storage (150) may also be another type of database such as, for example, an objected-oriented database or a NoSQL database. As such, the platform (100) may include a conventional database engine for accessing the data storage (150), e.g., using queries formulated using a conventional query language such as SQL, OQL, or the like.

In an embodiment, the communication platform (100) may include a conventional HTTP server application (e.g., Apache HTTP Server, Nginx, Microsoft IIS, or the like) adapting platform (100) to present dashboards, portals, and other interfaces in the form of web pages to web-enabled computing devices operated by the users of the platform (100). For example, interfaces of administrative interface subsystem (108) and user interface subsystem (206) may be presented by way of the HTTP server application.

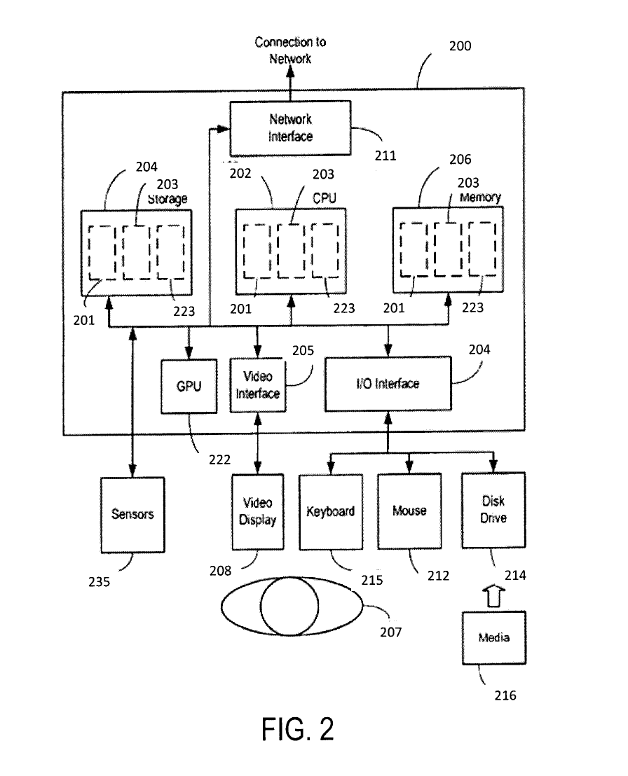

FIG. 2 is a schematic diagram of an example computing device (200) that may be used to implement communication platform (100), exemplary of an embodiment.

As shown, the computing device (200) may include at least one central processing unit (“CPU”) (102) connected to a storage unit (204) and to memory (206).

CPU (202) may be any type of processor, such as, for example, any type of general-purpose microprocessor or microcontroller (e.g., an Intel™ x86, PowerPC™, ARM™ processor, or the like), a digital signal processing (DSP) processor, an integrated circuit, or any combination thereof.

Storage unit (204) may include one or more storage devices such as a hard disk, solid-state disk, or the like. Storage unit (204) may also be partly or wholly cloud-based, accessible via a network such as network 170. Storage unit (204) may host data storage (150).

Memory (206) may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

The CPU (202) may process an operating system (201), applications (203), and data (223). Data (223) may include data corresponding to the one or more webpages of user interface subsystem (106) or administrative interface subsystem (108). The operating system (201), applications (203), and data (223) may be stored in storage unit (204) and loaded into memory (206), as may be required. Operating software (201) may, for example, be a Microsoft Windows™, Unix™, Linux™, OSX™ operating system or the like.

Applications (203) and data (223), when processed at CPU (202), provide the functionality of communication platform (100). Application (203) and any components thereof may each be implemented in a high level procedural or object oriented programming or scripting language, or both. However, alternatively, applications (203) and any components thereof may each be implemented in assembly or machine language, if desired. The language may be a compiled or interpreted language.

Computing device (200) may further include a graphics processing unit (GPU) 222 which is operatively connected to CPU (202) and to memory (206) to offload intensive image processing calculations from CPU (202) and run these calculations in parallel with CPU (102).

An operator (207) may interact with computing device (200) using a video display (208) connected by a video interface (205), and various input/output devices such as a keyboard (210), mouse (212), and disk drive (214) connected by an I/O interface (209). In known manners, mouse (212) may be configured to control movement of a cursor in video display (208), and to operate various graphical user interface (GUI) controls appearing in the video display (208) with a mouse button. Disk drive (214) may be configured to accept computer readable media (216).

Computing device (200) may connect to one or more networks via network interface (211). Network interface (211) allows the computing device (100) to communicate by way of wired or wireless communications with other computing devices by way of such networks.

The computing device (200) may be embodied in various form factors including one or more desktop and laptop computers, and wireless mobile computer devices such as tablets, smart phones and super phones. It will be appreciated that the present description does not limit the size or form factor of the computing device on which the present system and method may be embodied.

In some embodiments, computing devices (200) may have a different architecture or configuration, including a distributed server architecture, a server farm, or a cloud based computing environment.

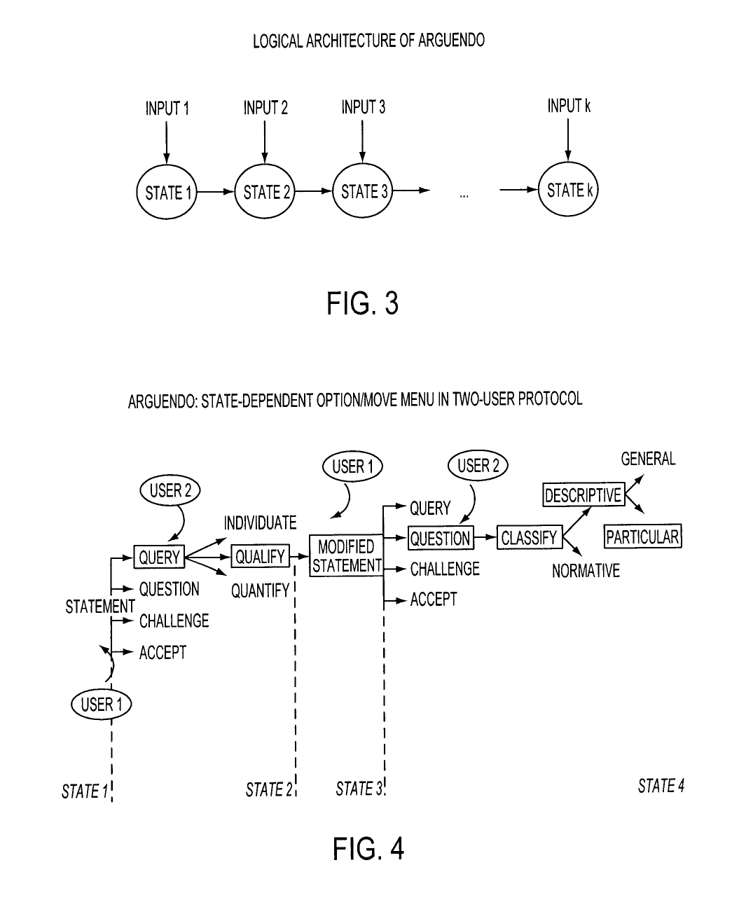

Referring now to FIG. 3, as noted above, aspects of the operation of the communication platform (100) may be modeled as a finite state machine.

As shown, user inputs (choices) determine the transition of the machine from one state to the next. The states are dependent jointly on (a) the last state of the machine, and (b) the input(s) of the user(s), namely, state k→input k+1=F(state k, options)→state k+1=G(user choice, state k).

In particular, as shown in FIG. 4, the state of platform (100) is governed by previous inputs (e.g., last statements, queries, challenges, answers, questions, answers input by user k). In return, the state of platform (100) constraints suggestions and option sets for new user inputs (queries, questions, classifications, challenges, answers, modified statements, etc).

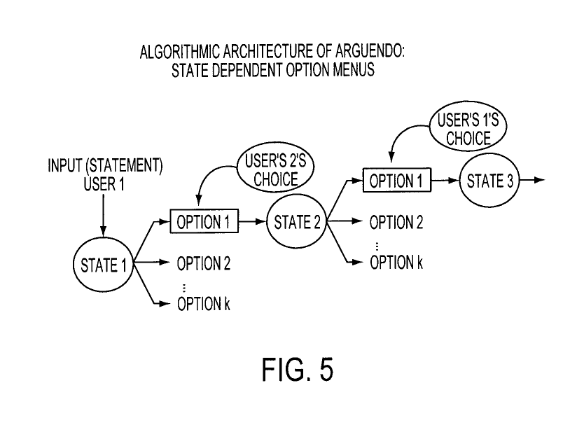

As shown in FIG. 5, upon registering a statement input by user 1 in State 1, the platform (100) in State 2 gives user 2 the option to query the statement in one of three different ways. Upon registering the query of user 2 (State 3), the platform (100) gives user 1 the option to answer the query and then modify the statement accordingly. Upon registering the modified statement input by user 1 (State 4), the platform (100) gives user 2 the option to question the statement, according to the class that the statement is in, and so on.

Each user is guided in his or her next moves by (i) the display of the current state of their dialogue, as provided by the platform (100), and (ii) a set of suggestions offered by the platform for the next move in the dialogue.

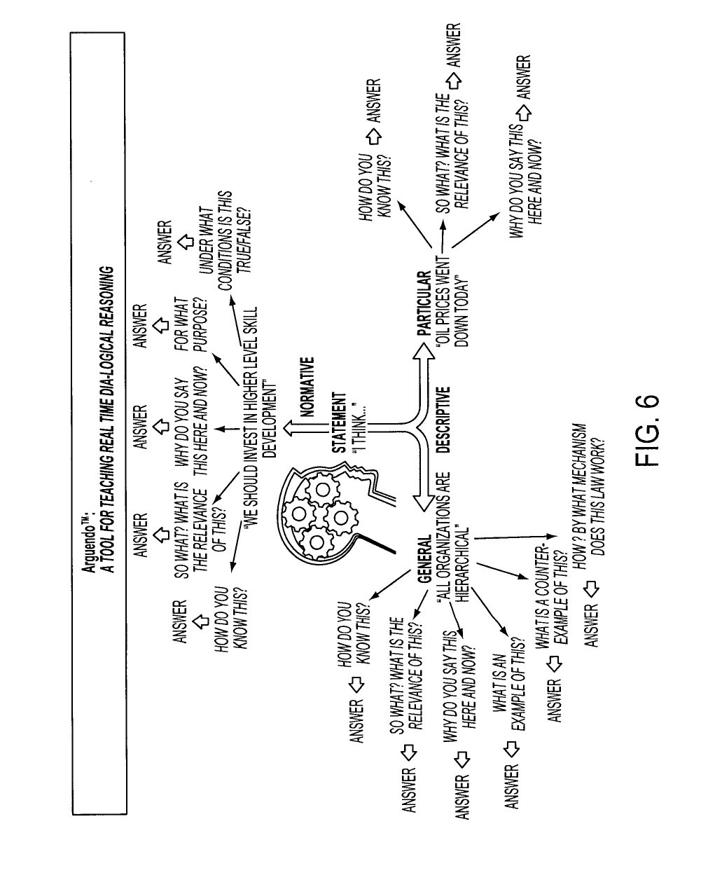

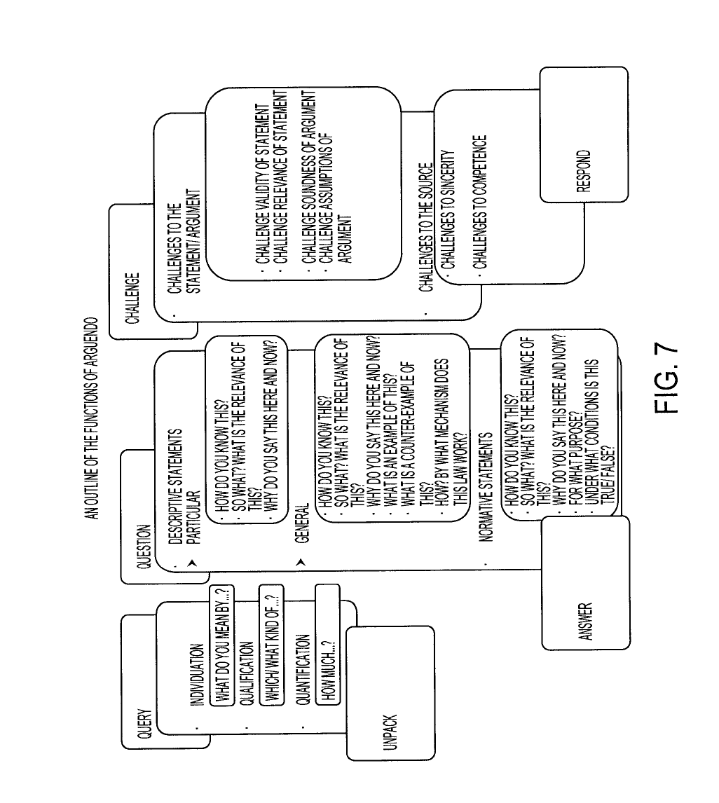

Communication platform (100) may be further described with reference to FIG. 6 and FIG. 7. In particular, FIG. 6 illustrates example guided dialogical processes implemented by the platform (100). As shown, in response a statement (e.g., a move of a proponent), a set of questions may be suggested (as a set of suggested moves for an opponent). In this way, platform (100) guides the dialogical process between proponents and opponents.

FIG. 7 illustrates the basic set of moves that the platform of FIG. 1 allows each user to make, as a function of the current state of the dialogue. These moves include:
a) Statements—the basic units of spoken and written arguments—fully formed sentences (in subject-predicate form) that can be input by the users directly upon being prompted by the platform;
b) Queries—(for instance: what do you mean by . . . ? How many is ‘most’?)—which comprise a set of prompts for clarification about the meaning and use of a statement, and which may be asked of one user by any other user and which are either selected by the user from a menu, or created by each user;
c) Clarifications of statements, which take the form of answers to the clarificatory queries;
d) Questions appropriate to each different kind of statement, which can be selected by the participants from a menu, and which allow users to probe into the justification for and validity of statement, into a user's purpose in making the statement, and into the relevance and informativeness of the statement in the context of the dialogical interaction between the users;
e) Answers to the questions raised by each participant, which are formulated and input by the participant to whom a question is posed, and which are themselves statements that can be queried and questioned;
f) Changes or modifications to statements, which are freely made by participants (speakers and interlocutors and/or instructors), depending on whether or not they are warranted by the answers they give to questions raised by interlocutors;
g) Arguments, which take the form of inferentially linked sets of statements comprising an original statement and a set of answers to questions raised about that statement.

For instance, ‘According to Time Magazine, drinking red wine decreases the incidence of heart disease in humans’ is a composite set of statements based on taking an original statement ‘red wine is good for you’, unpacking it (Q: what do you mean by ‘good for you’? A: it decreases the incidence of heart disease in people who consume it’) questioning it (Q: How do you know? A: I read about it in Time Magazine.’) and then chaining together the unpacked statement with the answer to the question (to get: ‘according to Time Magazine, drinking red wine decreases the incidence of heart disease in humans’).

Challenges to statements or linked sets of statement that may be raised by the opponent or an instructor, which are based on the nature of the statement and of the answers to questions about the statement. The platform (100) allows users to challenge statements and arguments—or, chains of linked statements—and to respond to these challenges interactively. The challenge system is structured to allow users to identify the specific statement or argument that they want to challenge, to select from among several different challenge forms, to input challenges that are targeted to different statements and arguments, and to respond to challenges that have been raised against a statement.

Challenges come in different kinds: Challenges to statements, including challenges to the validity and relevance of a statement; Challenges to arguments—or, sets of inferentially linked statements, including challenges to the soundness of an argument, or, the degree to which and the logic by which statements made in answer to questions about a statement support the statement; and, challenges to implicit assumptions, or, to statements that must be antecedently or independently true in order for a statement to be valid; challenges to sources cited or offered by users in support of the validity of a statement, including challenges to the competence of a source, or, to the ability of the source to come to know a statement to be true (or, false); challenges to the sincerity of a source, or, to the willingness of the source to make a true statement in the case of interest.

Responses to challenges raised to statements or linked sets of statements, formulated and input by a user as a result of challenges formulated and input by another user, including withdrawing the statement if he or she considers the challenge to be valid; querying the challenge, and therefore asking the challenger to unpack/clarify all or part of the challenge; questioning the challenger with respect to one or more of the statements that form the substance of the challenge; and/or challenging one or more of the challenger's statements, using the entire suite of challenges that the challenger himself has at his or her disposal.

Operation of platform (100) is recursive, in the sense that each answer to a query or a question, and each response to each challenge is itself a statement that can be queried, questioned and challenged by users.

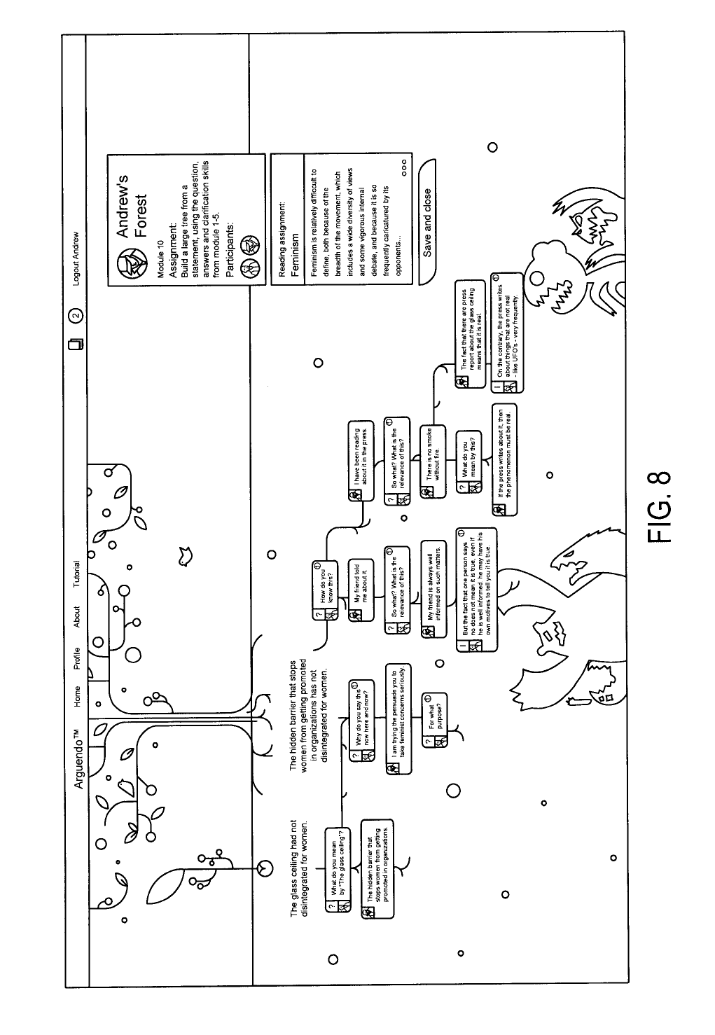

FIG. 8 shows an example screen of a web interface that includes history of a dialogue, as may be presented to users by user interface subsystem (106). As shown, the history of a dialogue among two or more users in the form of a tree whose stem(s) represent one or more statements (the content) and whose roots represent queries and clarifications, questions and answers, and challenges and responses input by users who are simultaneously logged into the platform.

As noted, interactions with platform (100) may be scored by dialogical evaluation subsystem (122). In particular, interactions may be scored according to the following metrics:
a) The relevance of a question to the statement it questions and to the dialogue (0 to n);
b) The responsiveness of an answer to the question it is meant to answer (0 to n);
c) The informativeness of an answer or response or clarification to the user who raised the query or question or challenge (0 to n);
d) The degree of support for an original statement that an answer to a question about the statement or the response to a challenge to the statement lends the statement itself (0 to n).

Together, these measures may be used to form a user score on that can be used as:
a) ‘Argumentation performance score’—if the platform is used as a training game;
b) ‘Game score’ if the platform is used as a social media content engagement platform;
c) ‘Performance evaluation score’ if the platform is used as an evaluative tool for users and/or statements;
d) ‘Learner outcome measure’ if the platform is used jointly as a training game and an evaluation game.

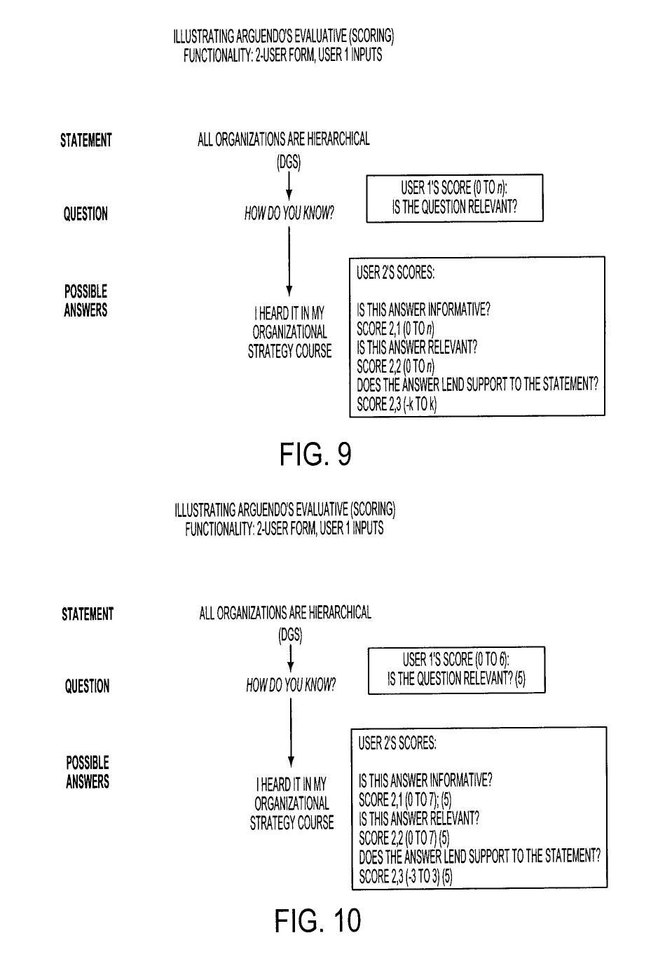

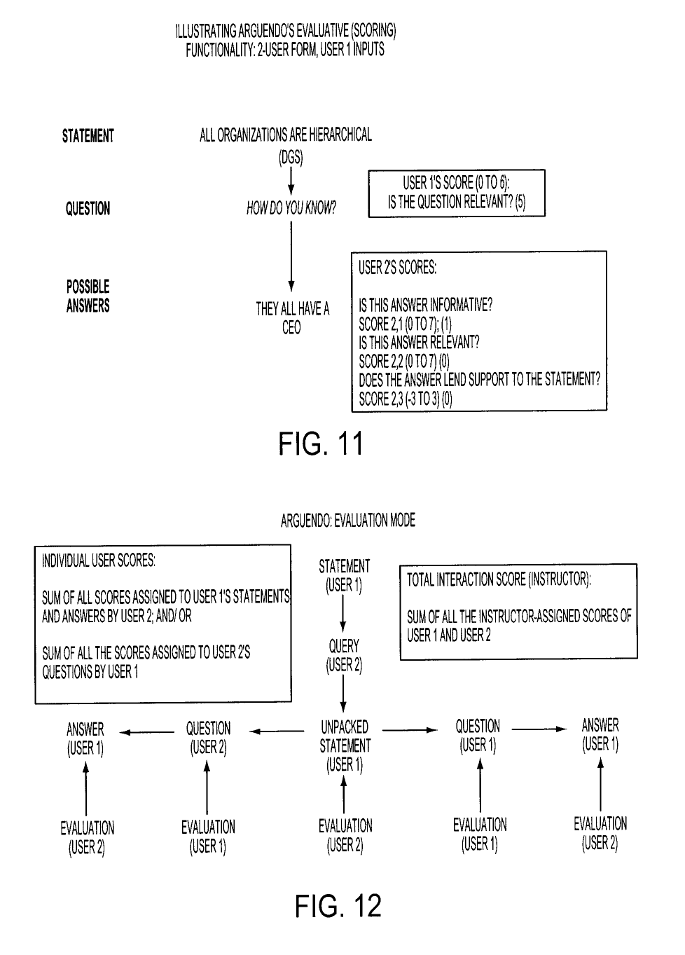

As shown in FIG. 9, users may be prompted to evaluate each other's contributions to a dialogue. In this case, User 1 has input the descriptive general statement ‘all organizations are hierarchical’. User 2 asks ‘How do you know?’ and User 1 answers ‘I heard in my Organizational Strategy course.’ User 1 is permitted to score the relevance of User 2's question (on a scale from 0 to n, where n is typically 4 or 6). User 2 is permitted to score the relevance of User 1's answer to the question (on a scale of 0 to n), the informative-ness of User 1's answer (on a scale of 0 to n) and the degree to which answer supports (or otherwise) the original statement (on a scale of 0 to n). FIG. 10 and FIG. 11 show examples of scoring inputted by users. In particular, FIG. 10 shows an example of a high-score question and a high-score answer, while FIG. 11 shows an example of a high-score question and a low-score answer, exemplary of an embodiment.

Referring to FIG. 12, the evaluation of dialogical evaluation subsystem (122) may be applied at the statement-question-answer level, at the argument level, and/or at the entire dialogue level. Based on the scores obtained (e.g., input by users or instructions or automatically calculated) for statements, questions and answers, scores for entire arguments (chains of statements that are linked by inferential steps) can be computed as the sum of the scores for the individual statements and answers to questions about statements.

Further, the score for an entire exchange or dialogical interaction can be computed as the sum of the scores for the statements, the answers to questions about questions and the questions that have been raised during the interaction. Therefore, platform (100) may function as a complete ‘dialogical scorekeeping’ and dialogical performance measurement tool, wherein the dialogical competence of participants in an interactive session may be evaluated, as well as the increase or decrease in dialogical competence with repeated usage of the platform (100). The performance measurement system can be used as either a developmental tool (to provide detailed feedback to participants on their dialogical skill) or as a selection/sorting system—to select users on the basis of their dialogical competence.

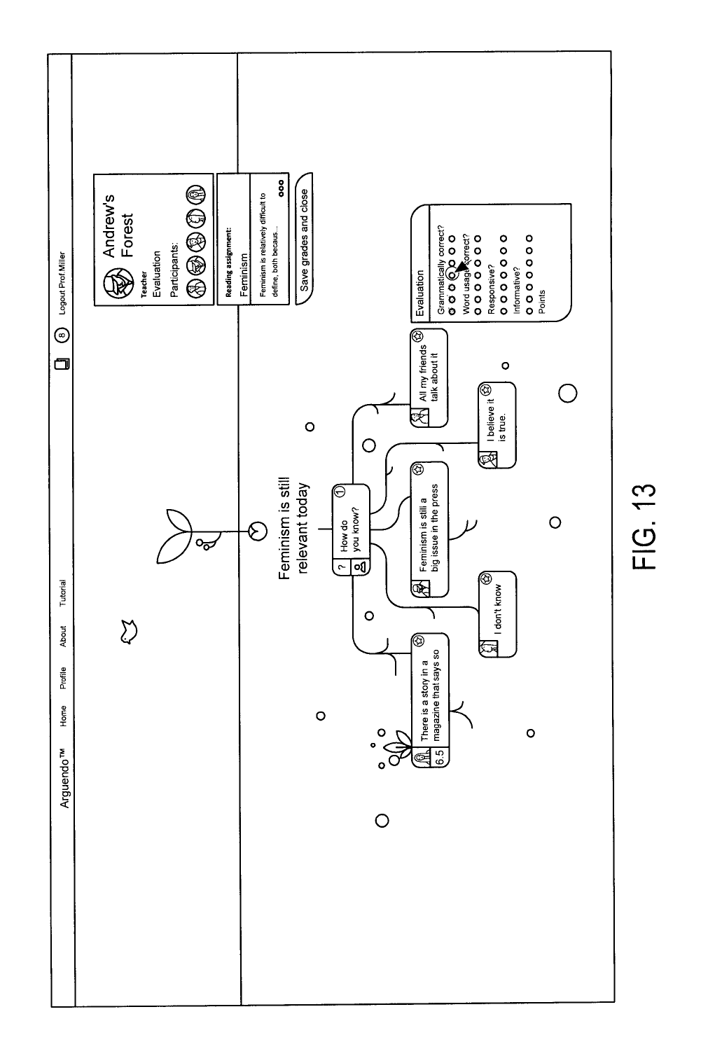

FIG. 13 shows an exemplary screen of a web interface that allows user to evaluate a statement according to various criteria (e.g., grammatically correct, word use correct, responsive, informative, etc.), as may be presented to users by user interface subsystem (106).

As noted, the analytics engine (124) may be configured to conduct various analyses and/or to generate various reports based on the stored information in data storage (150). In particular, data storage (150) may store a record of each dialogical move at the level of each user, each input; the type of each input (statement, query, question, challenge); and the statement or questions or query or challenge or response that the input responds or refers to.

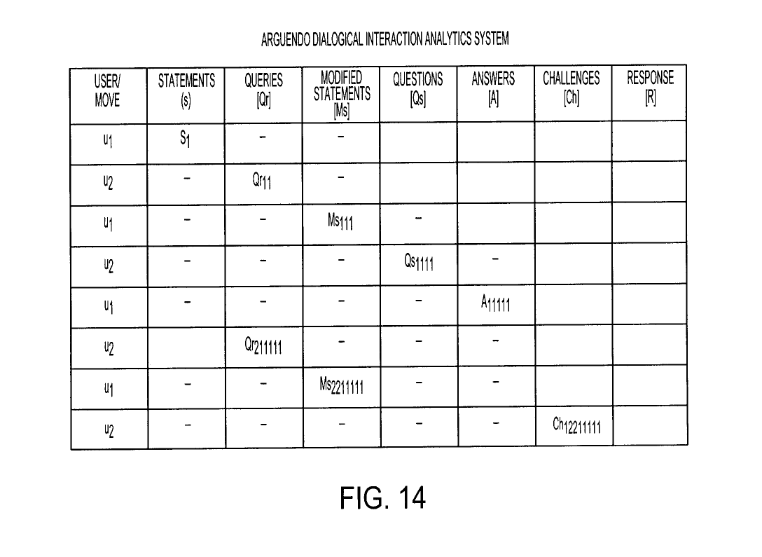

FIG. 14 shows an example data structure that may be used to organize stored records. As shown, if user 1 inputs statement S1 and user 2 queries S1, then the system registers the Query as Qr11 and places it in user 2's slot, where ‘Qr’ represents ‘query’, the first ‘1’ represents the fact that it is the first query, and the second ‘1’ represents the fact that the query is addressed to the first statement, S1. The first ‘1’ in other words, is the number of the query and the second 1 is the number of the statement it queries. If user 1 modifies the statement S1 to MS1 in response to user 2's query Qr11, then the system records the modified response as MS111 in user 1's slot, where, again, ‘MS’ refers to ‘modified statement, the first ‘1’ refers to the fact it is the first such statement input by user 1, the second 1 denotes the fact that the statement has been modified in response to the first query, and the last 1 denotes the fact that the query refers to the first statement. The data structure provides a numbering system that allows analytics engine (124) to track the path or the history of each exchange. The system produces a ‘linked list’ of statements, queries, modified statements, questions, answers, challenges and responses that allows analytics engine (124) to decode and represent the path of each dialogue, and to perform dialogical and reasoning analytics by displaying the path that each dialogue has followed.

In one aspect, platform (100) may be configured to provide a dialogical training tool, allowing students, as users, to interact with one another in a communication protocol structured by the platform (100) in relation to a particular piece of text. The text may be manually inputted by students, teachers, or automatically inputted into the platform (100) from a website, an electronic document, such as Word, Pages or pdf, or an electronic database (e.g., data storage 150), or the like. As a dialogical training tool, platform (100) may facilitate training with or without the participation of a teacher, and with or without the supervision of a teacher, as detailed below.

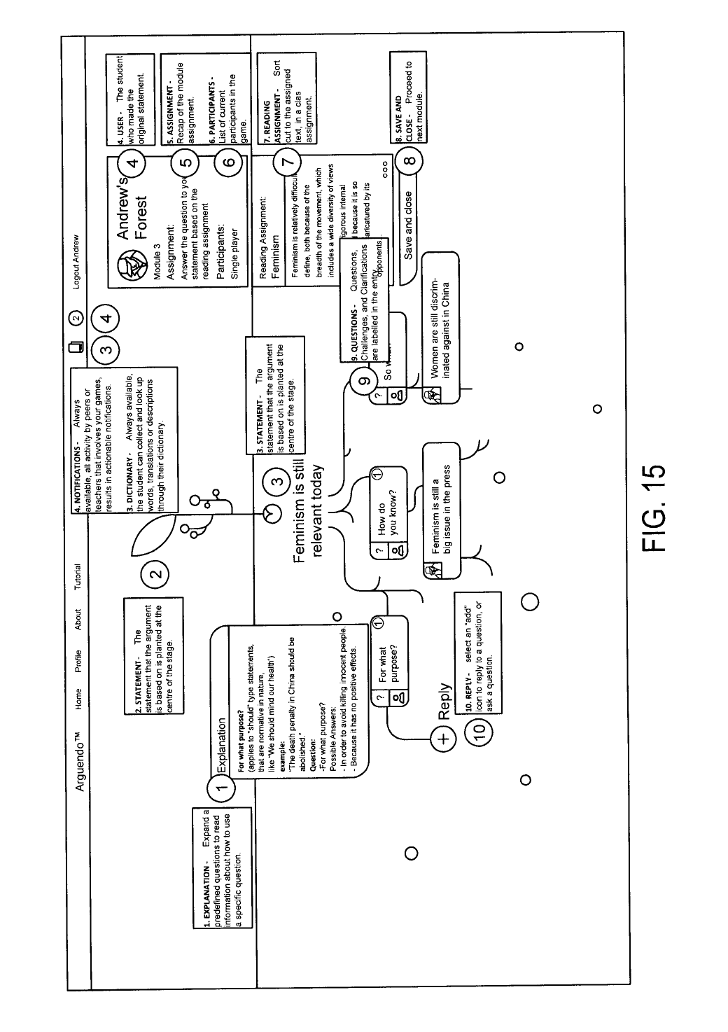

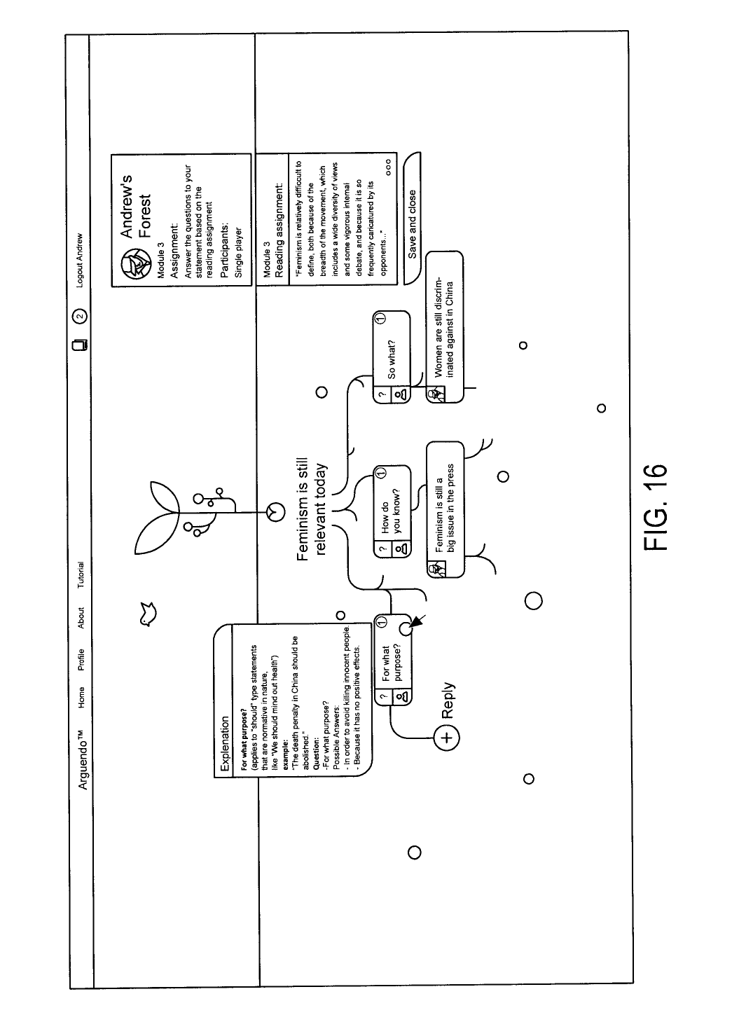

In an embodiment, platform (100) may be configured to provide specific explanations and/or instructions for the use of each of the suggested moves are provided to users interacting with one another through the platform. For example, FIG. 16 shows an exemplary screen including an explanation and instruction for the suggested move “For what purpose”.

In an embodiment, platform (100) may be configured to operate in one of a plurality of modes. Each mode may be suited for a particular training scenario, e.g., having a particular number of students (one or more), whether a teacher is participating, whether a teacher is supervising, etc. A particular mode may be selected by a user (e.g., a student or teacher) during operation from available modes, or may be selected by an administrator of platform (100).

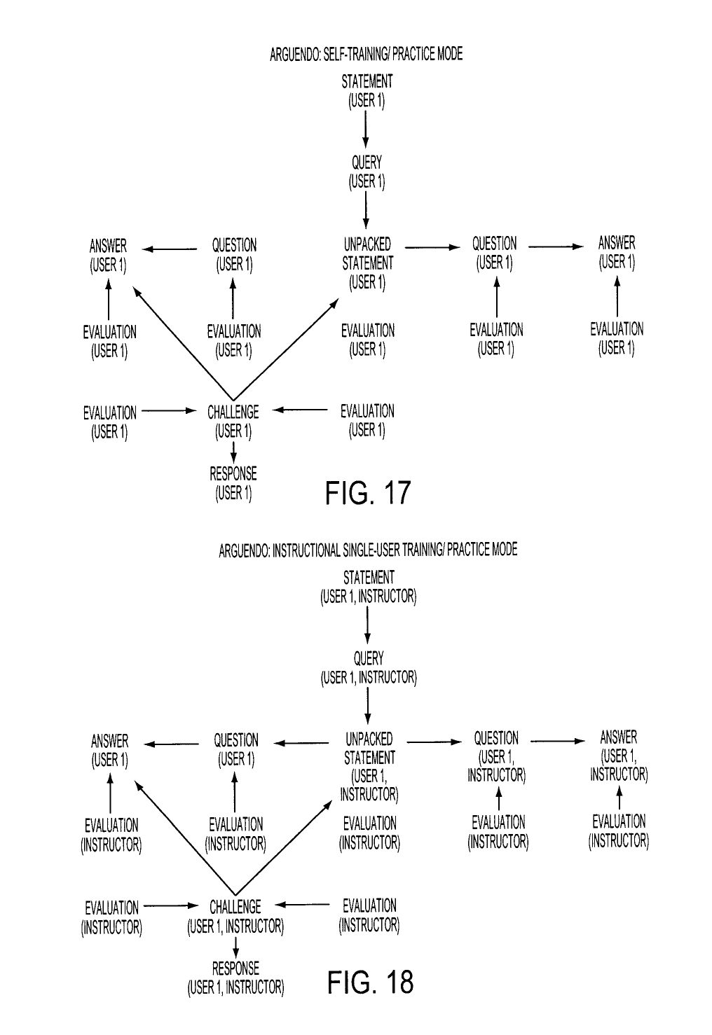

For example, platform (100) may include a “Self-Training/Practice Mode”, as shown in FIG. 17. In this mode, the platform can be used by a single user who wants to simulate a dialogue that would, or could, or should occur regarding a statement. As noted, the statement may be a statement drawn from text provided by the platform, or a statement that the user himself/herself provides. The user may be trained in the meaning of terms in the statement, and/or the justification for a statement, by performing a set of moves, such as queries, questions and challenges, upon a statement, and then answering queries, questions and challenges.

So, for example, in this mode, platform (100) allows the user to:
e) Input statements that he or she would like to get clear about, or to rehearse arguing for or against;
f) Query the statements with respect to meaning of the terms and phrases that appear in it (unpack);
g) Classify the statement(s) as descriptive (general or particular) or normative;
h) Question the statements and answer the questions that he or she selects to be answered;
i) Question (recursively the statements that appear as answers to any questions about statements already input;
j) Self-evaluate and self-score himself or herself on the relevance of the questions he or she asks, the informativeness and relevance of the answers she inputs in response to these questions, and on the level of support that answers to questions about statement lends to the credibility or validity of that statement;
k) Challenge his or her statement and chains of statements and respond to these challenges;
l) Self-evaluate and self-score the challenges he or she raises and the responses he or she gives to these challenges.

In another example, platform (100) may include a “Instructional Training and Practice Mode” that functions as a dialogical skill building tutorial tool, as shown in FIG. 18. In this mode, a user uses the platform together with an instructor, who supplies a set of statements the user queries, questions and challenges, or a set of queries, questions and challenges the user answers.

So, for example, in this mode, platform (100) allows a first user (the student) to:
a) Input statements that he or she would like to get clear about, or to rehearse arguing for or against;
b) Answer queries regarding the meaning(s) of terms and phrases that appear in the statement;
c) Classify the statement(s) as descriptive (general or particular) or normative;
d) Answer questions about statements that the instructor selects and put forth to be answered;
e) Self-evaluate and self-score her answers to questions raised by the instructor
f) Respond to the challenges raised by the instructor;
g) Self-evaluate and self-score the challenges he or she raises and the responses he or she gives to these challenges.

Meanwhile, platform (100) allows a second user (the teacher) to:
a) Input statements that he or she would like the student to query, question or challenge;
b) Input queries regarding the meanings of terms and phrases appearing in statements that are inputted by either him/herself and the student;
c) Challenge statements or chains of statements inputted by the student;
d) Evaluate and score answers given by the student to queries and questions, as well as responses given by the student to challenges that the instructor has raised;
e) Evaluate and score questions raised by the student, as well as challenges raised by the student to statements that the instructor has inputted.

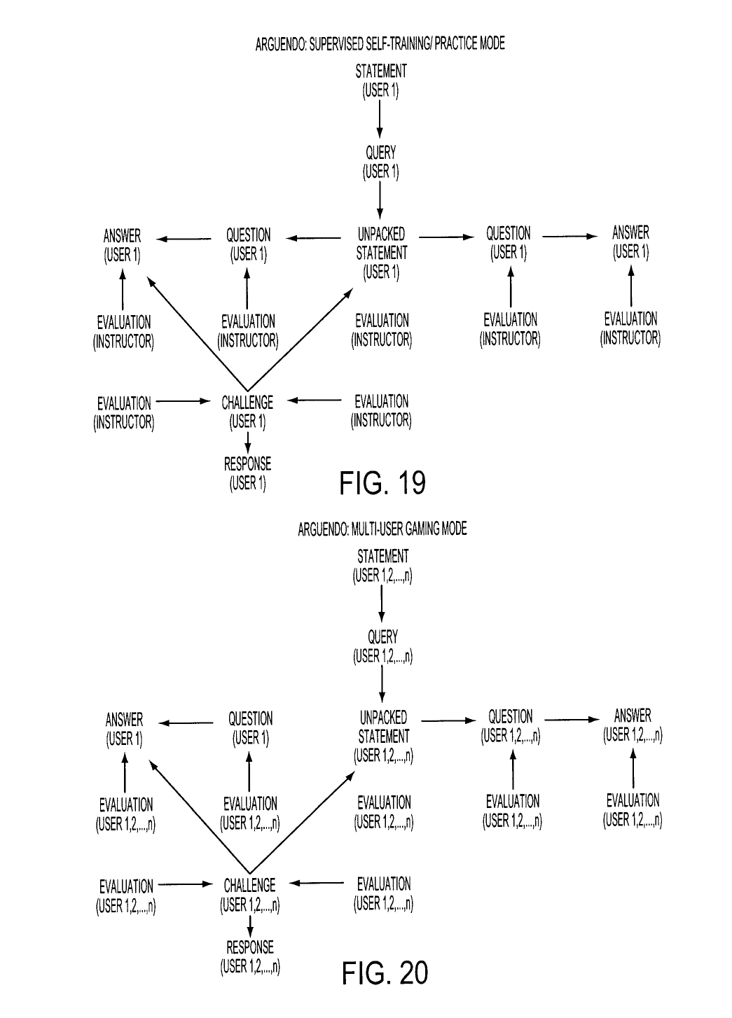

In another example, platform (100) may include a “Supervised Self-Training/Practice Mode” that functions as a supervised single user dialogical tutoring tool, as shown in FIG. 19. In this mode, the user posits statements, queries, clarifications, questions, answers, challenges and responses, that are visible to an instructor who provides feedback and/or evaluation and scoring of the user's inputs.

So, for example, in this mode, platform (100) allows a first user (the student) to:
a) Input statements that he or she would like to get clear about, or to rehearse arguing for or against;
b) Query the statements with respect to meaning of the terms and phrases that appear in it (unpack);
c) Classify the statement(s) as descriptive (general or particular) or normative;
d) Question the statements and answer the questions that he or she selects to be answered;
e) Question (recursively the statements that appear as answers to any questions about statements already inputted;
f) Self-evaluate and self-score himself or herself on the relevance of the questions he or she asks, the informativeness and relevance of the answers she inputs in response to these questions, and on the level of support that answers to questions about statement lends to the credibility or validity of that statement;
g) Challenge his or her statement and chains of statements and respond to these challenges;
h) Self-evaluate and self-score the challenges he or she raises and the responses he or she gives to these challenges.

Meanwhile, platform (100) allows a second user (the teacher) to:
a) Evaluate and score the student's questions with respect to their relevance;
b) Evaluate and score the student's answers to questions with respect to their relevance, informativeness and the degree of support these answers lend to the student's statements;
c) Evaluate and score the student's challenges and responses to his or her challenges.

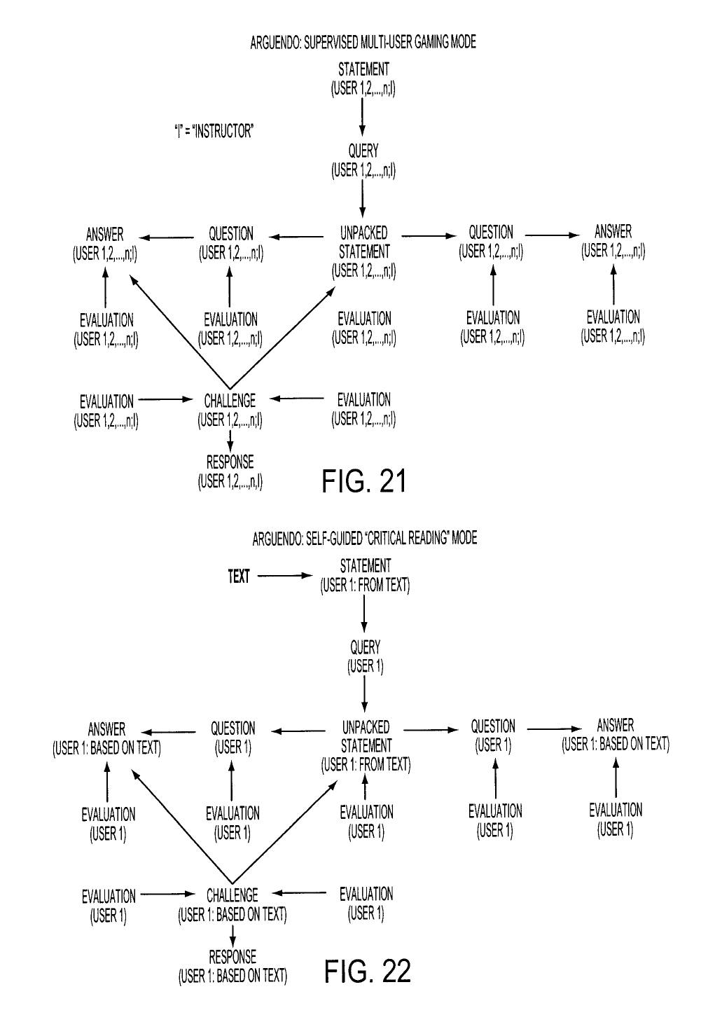

In another example, platform (10) may include a “Multi-User ‘Gaming’ Mode” that may be used by multiple students who want to practice their dialogical moves on one another, without the supervision of an instructor, as shown in FIG. 20. The platform (10) may also include a “Supervised Multi-User ‘Gaming’ Mode” that is similar to the above-noted “Multi-User ‘Gaming’ Mode”, but provides for supervision of an instructor to whom their moves are visible, as shown in FIG. 21.

So, for example, in these modes, platform (100) allows each user (students) to:
a) Input statements that he or she would like to put forth as representing what he or she believes to be true or appropriate;
b) Query the statements inputted by other users with respect to meaning of the terms and phrases that appear in it (unpack);
c) Classify his or her own statement(s) as descriptive (general or particular) or normative;
d) Question the statements inputted by other users and answer questions regarding his or her statements;
e) Question (recursively) the statements inputted by other users that appear as answers to any questions about statements already inputted;
f) Evaluate and score other users on the relevance of the questions he or she asks, the informativeness and relevance of the answers she inputs in response to these questions, and on the level of support that answers to questions about statement lends to the credibility or validity of that statement;
g) Challenge other users' statement and chains of statements and respond to these challenges;
h) Evaluate and score the challenges other users raise and/or the responses other users give to his or her own challenges.

Meanwhile, in the “Supervised Multi-User ‘Gaming’ Mode”, an instructor can observe one or more interactive sessions taking place online at the same time, and use any of the functions available to any one of the multiple users to evaluate users' statements, queries, questions, answers, challenges and responses and to give users detailed targeted using a chat interface.

In another example, platform (100) may include a “Self-Guided ‘Critical Reading’ Mode” that functions as an unsupervised ‘critical reading’ assistant, as shown in FIG. 22. In this mode, user(s) communicate with one another regarding (i.e. ‘taking as input’) statements drawn from a piece of text provided by another user of the platform and displayed by the platform and attempt to clarify, justify or challenge the statement using textual evidence occurring within the text provided. The platform (10) may also include a corresponding supervised mode in which an instructor can observe the session

So, for example, in these modes, platform (100) allows users (students) to:
a) Input statements drawn from a text that he or she would like to focus on;
b) Query the statements with respect to meaning of the terms and phrases that appear in it (unpack) and answer these queries with statements drawn or inferred from the text;
c) Classify the statement(s) as descriptive (general or particular) or normative;
d) Question the statements (‘How does the author know . . . ?’, or, ‘Why does the author think . . . is relevant?’ and answer the questions that he or she selects to be answered on the basis of the information supplied by the text;
e) Question (recursively the statements that appear as answers to any questions about statements already inputted;
f) Self-evaluate and self-score himself or herself on the relevance of the questions he or she asks, the informativeness and relevance of the answers she inputs in response to these questions, and on the level of support that answers to questions about statement, drawn from the text lends to the credibility or validity of that statement;
g) Identify challenges that the author of the text raises with regard to his or her own statements and responses that the author of the text offers to these challenges;
h) Self-evaluate and self-score the challenges he or she perceives the author to be raising and the responses he or she perceives the author gives to these challenges.

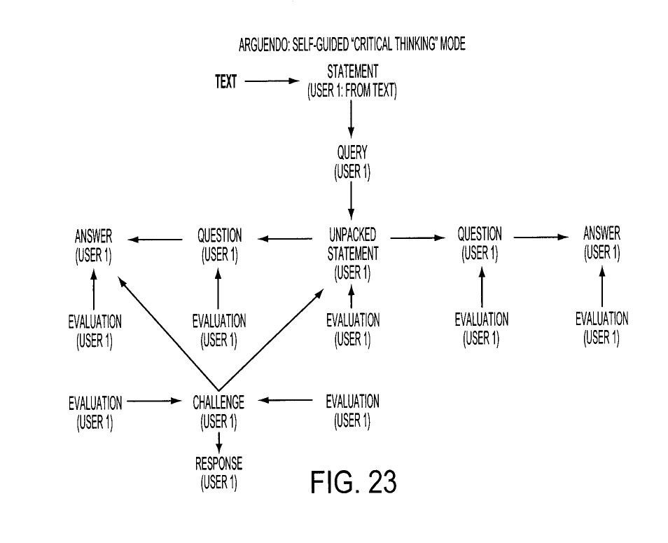

In another example, platform (100) may include a “Self-Guided ‘Critical Thinking’ Mode” that may be used as an unsupervised ‘critical thinking’ assistant, as shown in FIG. 23. In this mode, users communicate with one another regarding statements that are about a piece of text provided by another user and displayed by the platform, and attempt to clarify, justify or challenge the said statement using textual evidence occurring outside the text provided. The platform (10) may also include a corresponding supervised mode in which an instructor can observe the session

So, for example, in these modes, platform (100) allows users (students) to:
a) Input statements drawn from a text that he or she would like to focus on;
b) Query the statements with respect to meaning of the terms and phrases that appear in it (unpack) and answer these queries with statements that are either drawn or inferred from the text or from other texts, or from the user's own experience and knowledge;
c) Classify the statement(s) she has selected as descriptive (general or particular) or normative;
d) Question the statements (‘How does the author know . . . ?’, or, ‘Why does the author think . . . is relevant?’ and answer the questions that he or she selects to be answered on the basis of the information supplied by the text or by other texts and/or the user's own experience and knowledge;
e) Question (recursively the statements that appear as answers to any questions about statements already input;
f) Self-evaluate and self-score himself or herself on the relevance of the questions he or she asks, the informativeness and relevance of the answers she inputs in response to these questions, and on the level of support that answers to questions about statement, drawn from the text lends to the credibility or validity of that statement;
g) Challenge statements or linked sets of statements appearing in the text, on the basis of either the text itself, or on other texts, or on the user's own experience and knowledge and respond to such challenges;
h) Self-evaluate and self-score the challenges he or she has raised and the responses he or she perceives the author gives to these challenges or that she herself gives to the challenges on the basis of the text, or of some other text, or of her own experience and knowledge.

### Examples of Suggested Dialogical Moves

As noted above, platform (100) is configured to provide a set of suggested moves (e.g., questions of various types and challenges of various) to a user (e.g., a user 202) according to the previous move (e.g., Statement, Clarification, Response) that the previous user (e.g., a user 203) has made.

In forming a suggestion, platform (100) may take into account not only the statement, but also a variety of contextual factors including: (i) previous exchanges associated with the active conversation; and/or (ii) other conversations linked to the platform that are related to the active conversation including, for example, as it relates to the topic of conversation, the positions being advanced by participants, and so on.

For example, the set of suggested moves may comprise (i) a set of questions that aim to establish the credibility and sincerity of the user that has put the statement forth, and the validity and reliability of the statement, and a set of challenges that are meant to attack the validity or reliability of the statement, or the sincerity or competence of the user that has put forth the statement.

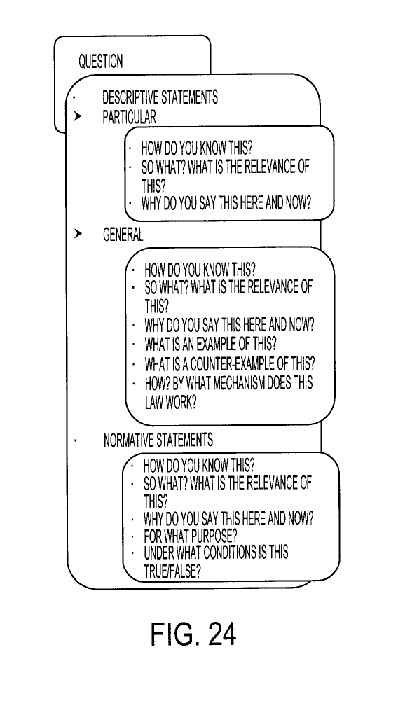

Suggestions for questions are dependent upon the kind of statement (or, in one instance, statements that are answers to questions about a statement, or responses to challenges to a statement, or clarifications offered in response to queries about a statement). As shown in FIG. 24, in one instance, statements may be classified by their proponents as follows:

Descriptive, particular (e.g.: Today is Tuesday; The NASDAQ is down 20 points today; 46% of American citizens living today are overweight’); or

Descriptive, General (e.g.: All hierarchies are led by men’; All humans are motivated by self interest’); or

Normative (e.g.: ‘We should impose or maintain the death penalty in China; We should start an entrepreneurship incubator at our university’).

In an embodiment, statements may be automatically classified by platform (100).

Platform (100) makes suggestions to each opponent for questions that can be raised with regard to a statement. For example, the suggested questions may include:

a) How do you know?

b) By what mechanism does this happen?

c) What is an example of this?

d) What is a counterexample of this?

e) For what purpose (should we do this)?

f) Why do you say this here and now?

g) Under what conditions is this true?

h) Under what conditions is this false?

The suggestions for questions may be dependent upon the classification of the statement.

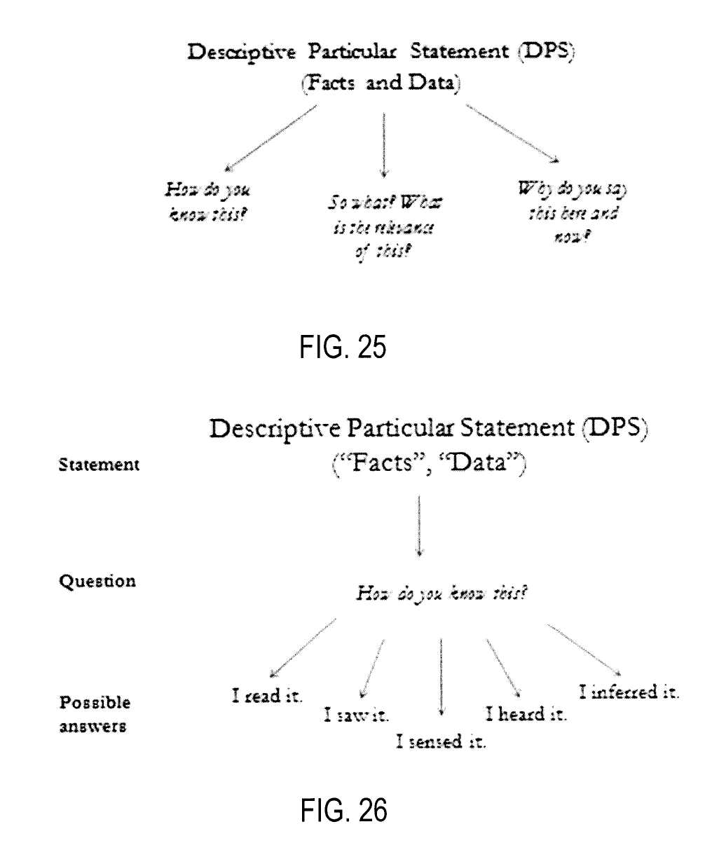

For example, FIG. 25 shows questions that may be suggested for a descriptive particular statement. Platform (100) may suggest these questions (e.g., ‘How do you know this?’ or ‘Why do you believe this?’), and allow a user to ask one or more of these questions to another user in response to the descriptive particular statement.

Such questions are meant to test the user's warrant for believing in the validity of the statement that he or she has made. FIG. 26 shows possible answers to such a question, which include:

a) I read it;

b) I saw it;

c) I sensed it;

d) I heard it;

e) I inferred it from . . . or I deduced it from . . . .

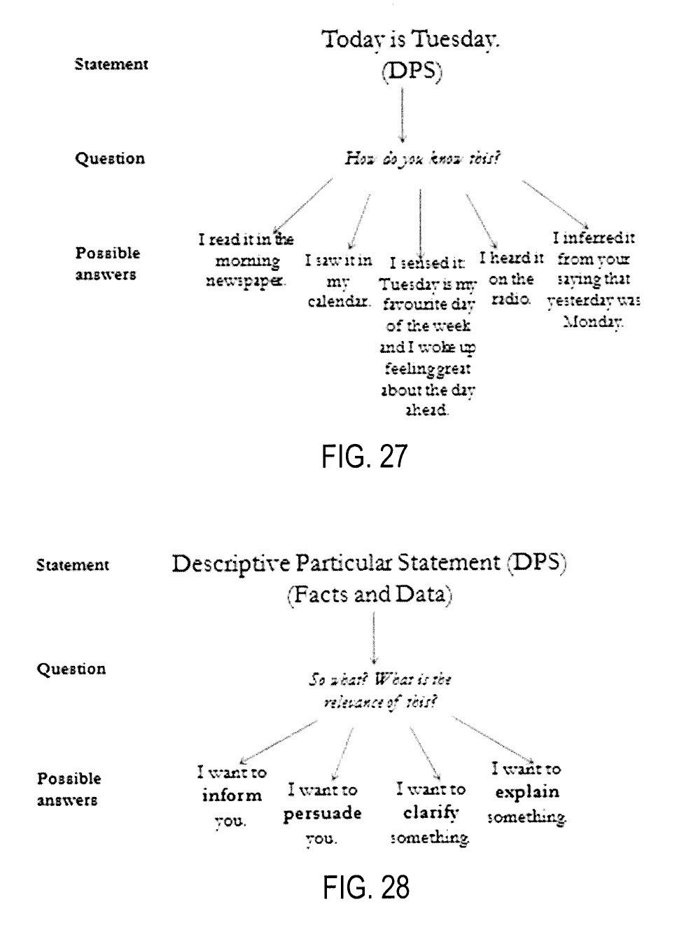

For example, as shown in FIG. 27, if the statement being put forth by the user is ‘Today is Tuesday’ (classified as a descriptive particular statement), and another user asks ‘How do you know this?’ then the user may answer: “I saw it in my calendar just now’, or ‘I inferred it from the fact that I know that yesterday was Monday’ or, ‘I heard someone say it a few minutes ago’, and so forth.

As shown in FIG. 28, a user may also ask another user: ‘So what? What is the relevance of this?’ This is a question meant to test the relevance of the statement to the dialogue or the conversation. As shown, possible answers to this question include:

a) I want to inform you that . . . .

b) I want to explain something . . . .

c) I want to clarify something . . . .

d) I want to persuade you to . . . .

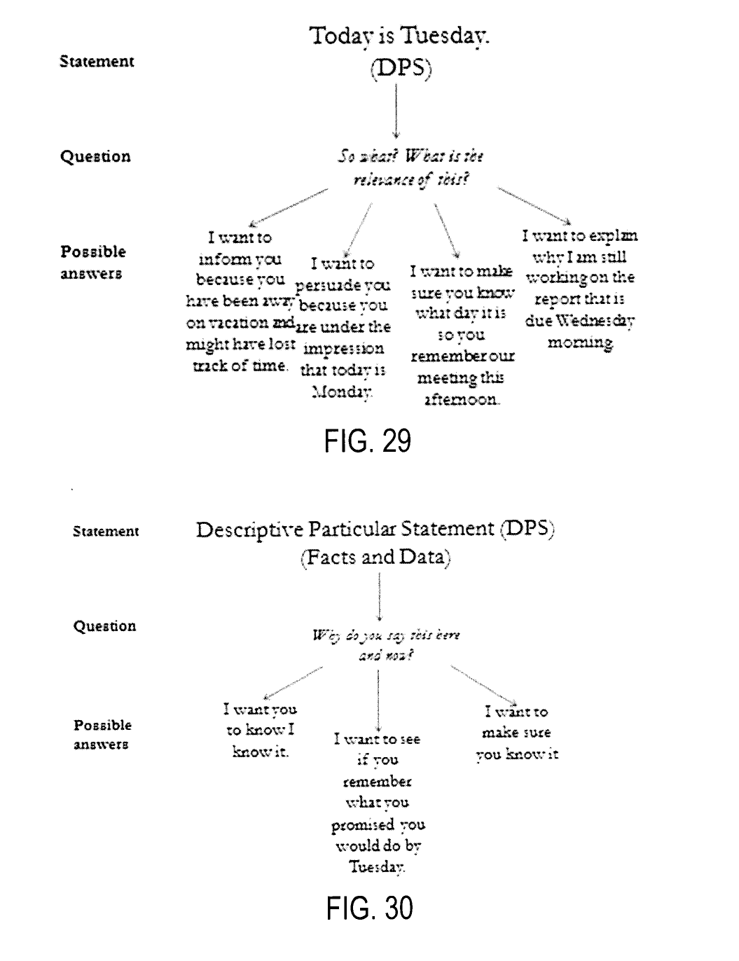

FIG. 29 shows examples of actual responses to answers to ‘So what?’ regarding the statement ‘Today is Tuesday’.

As shown in FIG. 30, a user may also ask another user: ‘Why do you say this here and now?’ This question probes into the intent of the user that has put forth the statement, his or her motivation(s) for asserting the statement at this point in time. As shown, possible answers to this question may overlap with answers to ‘So what?’, but will additionally include answers that demarcate the specifics of the situation and the context in which the conversation takes place:

a) I want you to know I know it;

b) I want you to do something today which can only be done on Tuesday;

c) I want to see if you remember what you promised you would do ‘by Tuesday’.

Each answer to a question posed in through platform (100) becomes a statement that may be questioned further. Consequently, new questions may be input by a user regarding statements inputted by another user in answer to questions raised by the first user. Each answer becomes part of a chain of inference and argumentation that extends as far as the users are willing to continue interacting using the interface.

Platform (100) allows users to ask one of a possible set of questions about descriptive general statements inputted by other users, and to register answers to these questions.

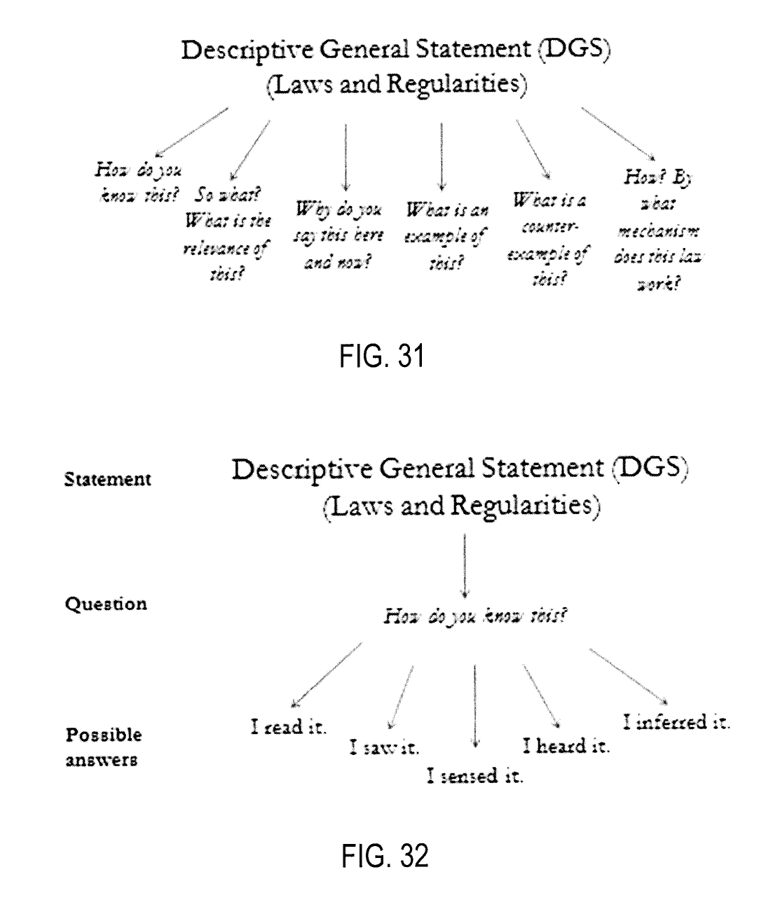

For example, FIG. 31 shows questions that may be suggested for a descriptive general statement.

The question may, for example, be ‘How do you know?’ or ‘Why do you believe this?’ As in the case of descriptive particular statements, users may ask for a warrant or a reason for knowing or believing the statement in question to be true, valid, probable or plausible. As in the case of descriptive particular statements, answers to ‘How do you know/Why do you believe . . . ?’ questions can take different forms which relate to the grounds or the reason for believing in the truth, validity, plausibility or probability of the statement, as shown in FIG. 32.

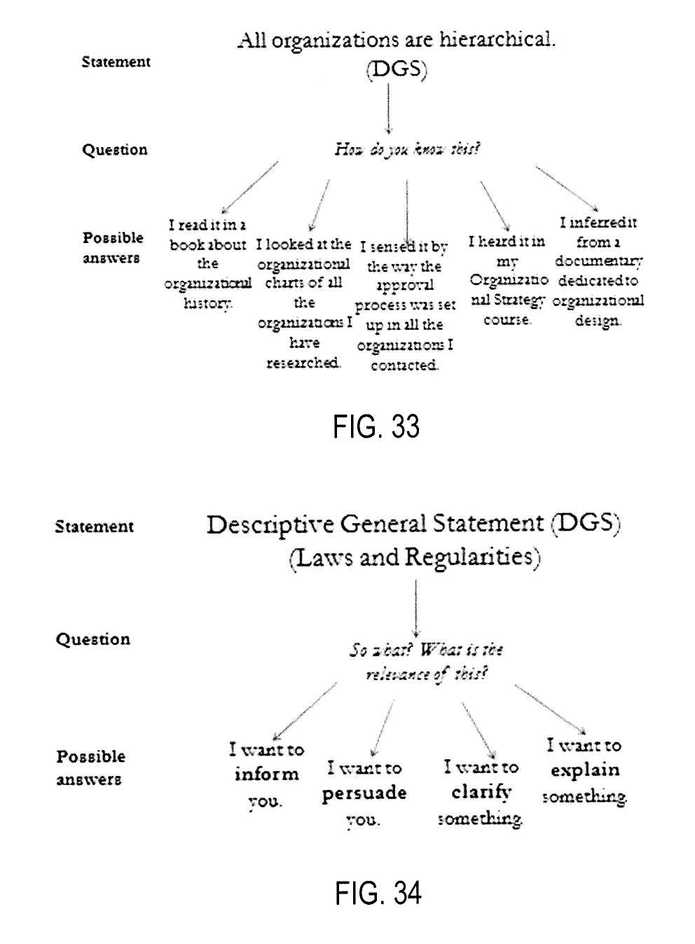

For example, as shown in FIG. 33, if the statement is ‘All organizations are hierarchical’ and the user that put forth the statement is asked by another user ‘How do you know?’, the former can input any one or several of a number of answers that give his or her reason for believing, knowing or asserting the statement to be true, which are based either on direct (‘I inspected 1,000,000 organizational charts and found they were all hierarchical’) or indirect (‘I have read a report that claims this is true’) grounds.

As in the case of descriptive particular statements, users may ask ‘So what?’ or, ‘What is the relevance of this statement?’ about descriptive general statements inputted by other users. As shown in FIG. 34, answers to questions about relevance of statements may be ‘I want to inform you’, ‘I want to persuade you’, and ‘I want to clarify or explain something’.

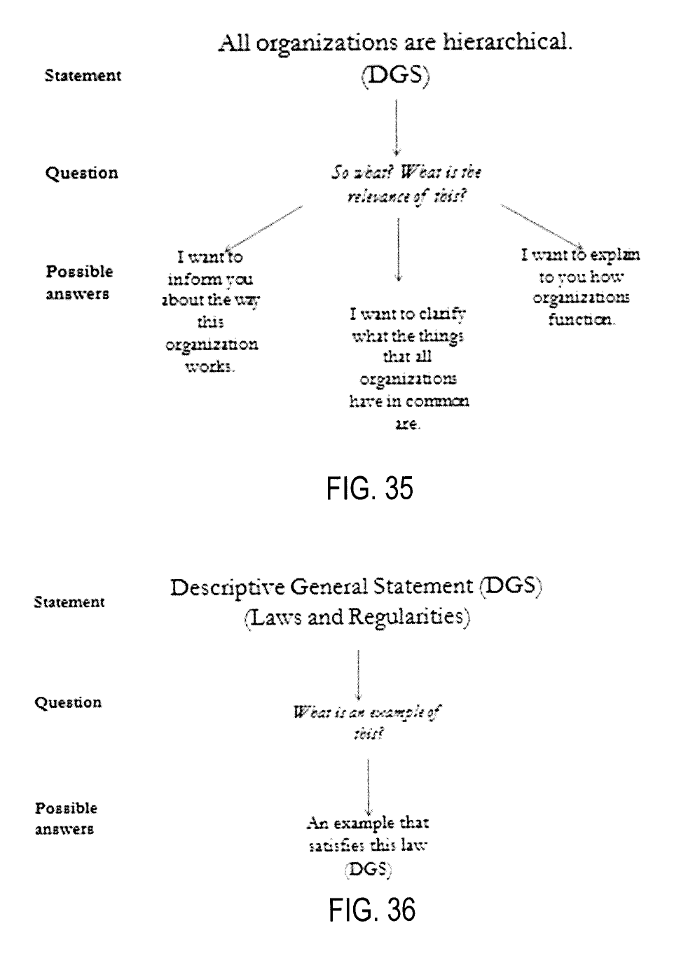

If the original statement inputted by the user is ‘all organizations are hierarchical’, then possible answers to ‘so what?’ questions regarding this statement include statements such as ‘I want to inform you about how this organization works’, ‘I want to clarify what I believe all organizations have in common”, and so forth, as shown in FIG. 35.

Descriptive general statements differ from descriptive particular statements in that they have extensions—or sets of objects and events to which they refer as a whole, as may be inferred from the fact that they use the qualifier ‘All’. For this reason, the following two sets of questions may be suggested, which are meant to specifically probe into the grounds that the user that has put forth a statement has for the claim that the statement applies in all particular cases, as follows.

As shown in FIG. 36, the question may be ‘What is an example of this?’ A user may ask another user who has put forth the statement ‘all organizations are hierarchical’ for one or several examples of organizations that are indeed hierarchical.

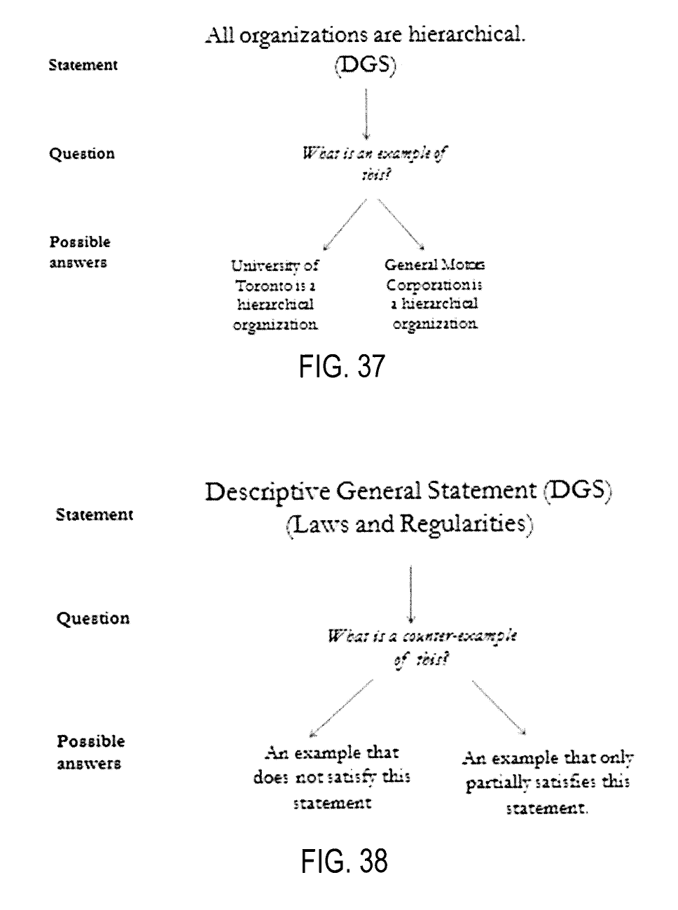

Answers to this question will give instances of specific organizations that are hierarchical, e.g.: the University of Toronto, or General Motors Corporation, as shown in FIG. 37.

As shown in FIG. 38, the question may be ‘What is a counterexample of this?’ A user may also ask the user who has inputted the statement ‘all organizations are hierarchical’ for counter examples to this general statement, i.e. for organizations that are not hierarchical, or for organizations that are not hierarchical all the time or that have different hierarchies according to expertise and which vary according to the collective tasks they are trying to pursue.

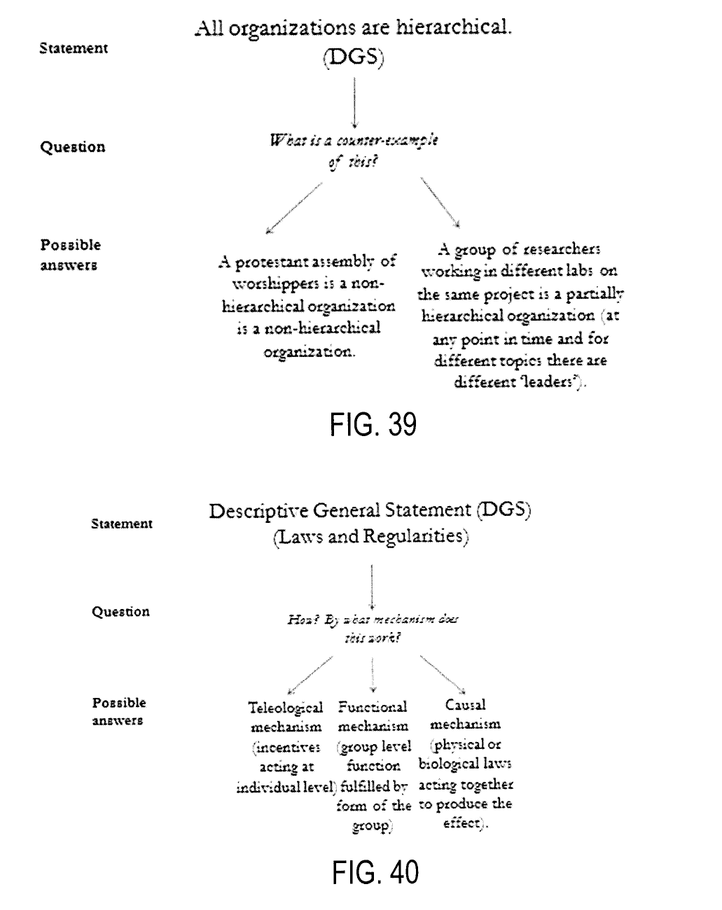

As shown in FIG. 39, in the case of the descriptive general statement ‘all organizations are hierarchical’, a counterexample may be a protestant assembly of worshippers, which is non-hierarchical; or, a group of researchers trying to make progress on a single research question that have several and different ‘leaders’ at various times, and according to the area(s) of personal expertise.

As shown in FIG. 40, the question may be ‘By what mechanism does this work?’ Descriptive general statements are also different from descriptive particular statements in that the law-like or universal character of their claims opens them up to ‘How?’ questions, or questions regarding the underlying mechanism(s) by which the law-like generalization comes to be valid. The (causal) mechanism of gravitational attraction, for instance, answers the ‘how?’ or ‘by what mechanism?’ question regarding the descriptive general statement ‘all objects tend to fall (towards the Earth)’. When asked ‘How?’ or ‘By what mechanism?’ a user that has inputted a general descriptive statement may give answers that specify mechanisms that are causal (like the gravitational law), teleological (which explain why the law expressed by the statement is valid—and therefore why the statement is true—on the basis of individual level incentives and motivations, as in the case of economic models of incentive effects in teams) or functional (which explain why the law is valid on the basis of the fit between the function of an entity and its form or structure or dynamics, as in the case of evolutionary models of biological structures and dynamics).

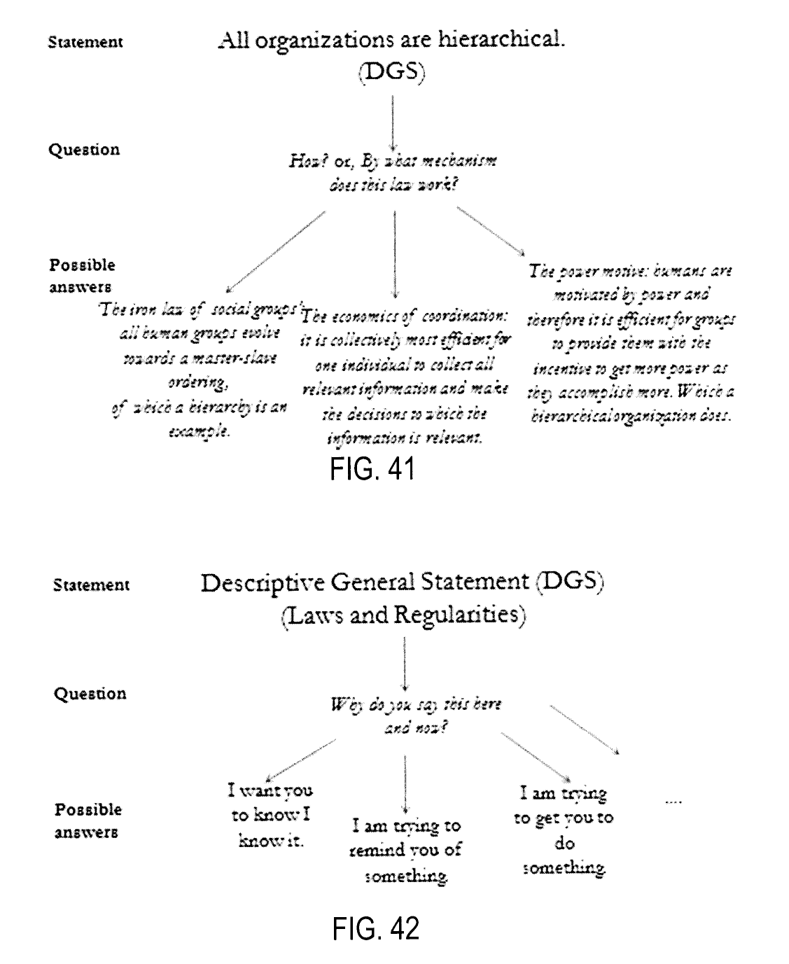

For example, as shown in FIG. 41, if the user who has inputted the descriptive general statement ‘all organizations are hierarchical’ is asked ‘By what mechanism is this law valid?’ by another user, he or she may answer that this law ‘works’ because the hierarchical form enables optimal coordination between individuals trying to work together (functional explanation) or because of the incentive effects of the power motive at the individual level (teleological explanation) or even that hierarchies embody the ‘master-slave’ structure that all human groups evolve to (which may be causal or structural).

As shown in FIG. 42, the question may be ‘Why do you say this here and now?’ As with descriptive particular statements, users can inquire into the intent the proponent has in making the statement in this context, i.e. ‘Why do you say this here and now?’ This question from ‘So what?’ or ‘what is the relevance of this statement?’ in that it asks about the speaker's intent in making the statement and the connection between this intent and the context, rather than about the relevance of the statement to some other statement or to earlier statements. Possible answers include (but are clearly not limited to) ones such as the following: “I want you to know that I know it”, “I am trying to get you to do [something]”, or, ‘I am trying to remind you [of something].”

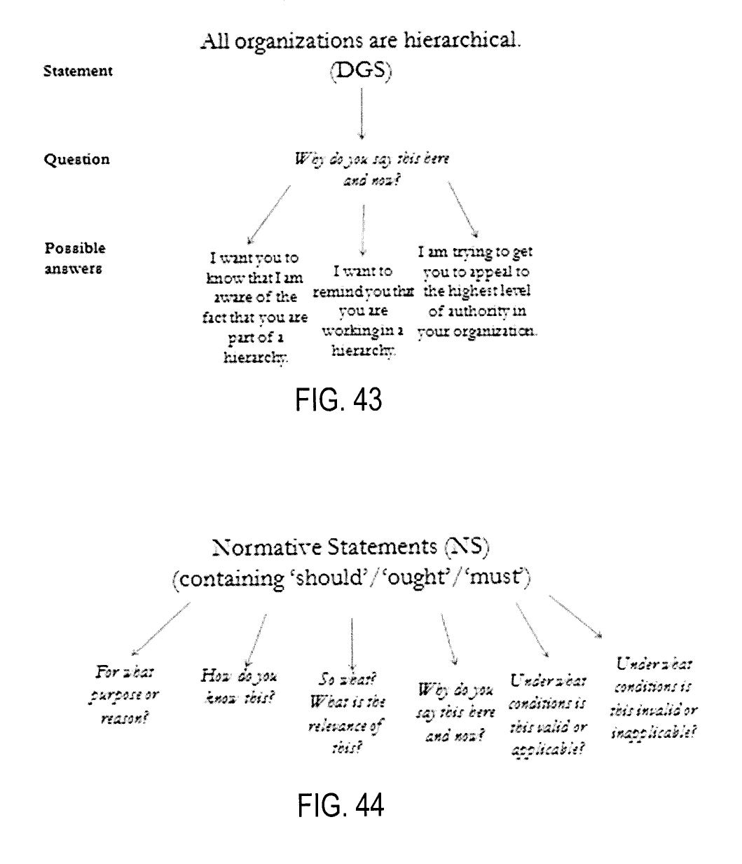

For example, as shown in FIG. 43, if the descriptive general statement inputted by one user is ‘all organizations are hierarchical’ and the second user asks ‘Why do you say this here now?”, the first user may give answers that are statements about his or her intent in putting forth the statement, e.g., “I am trying to persuade you to appeal to the highest level of authority in your organization.’, or, ‘I want you to know I am aware that you are working in a hierarchy.”

Unlike descriptive statements of either the particular or general kind, normative statements (containing ‘should’, ‘ought to’, the normative ‘must’—as in ‘must obey this law’ or ‘must follow this rule’ and on occasion even ‘want’ or would’—as in ‘we want to be fair’ or ‘we would like to be impartial’) represent claims on the allegiance and the commitment of the user and other users, rather than just descriptions of states of affairs. These claims are deeper and broader than those made by descriptive statements, and, for this reason, they need to answer to a broader and deeper set of questions than those to which descriptive statements answer.

Platform (100) also allows users to ask one another and answer questions regarding normative statements, as shown in FIG. 44.

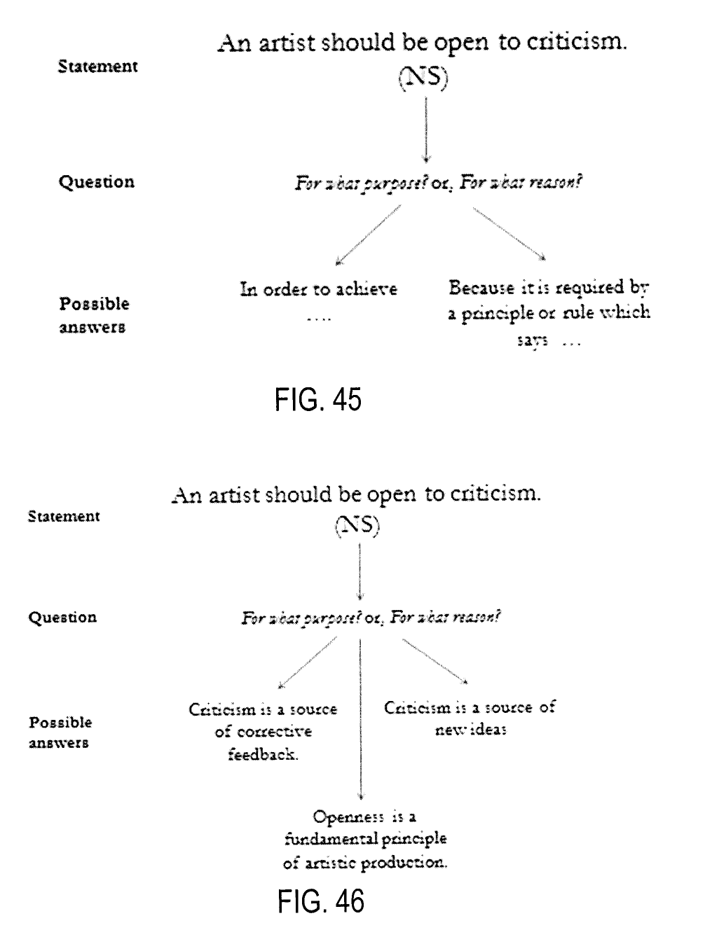

As shown in FIG. 45, the question may be ‘For what purpose or what reason?’ Users can ask other users who have inputted a normative statement ‘For what purpose?’ or ‘for what reason?’ regarding the injunction expressed by the statement (eg: You should do X). Possible answers to ‘for what purpose?/For what reason?’ questions include: ‘Because doing so helps to achieve . . . ’ or ‘Because doing so is required by the rule or principle that says . . . ’.

For example, as shown in FIG. 46, if a user inputs the statement ‘An artist should be open to criticism’ and the second user asks ‘For what purpose or reason?’, then the first user may give answers such as “Criticism is a valuable source of corrective feedback”, or “Openness is a fundamental rule or principle of artistic activity”. The question admits of both answers that specify a higher-order goal (which would be achieved if the injunction expressed by the normative statement is followed) or a rule or principle that requires one to follow the injunction expressed by the statement (e.g. “openness is a fundamental rule of artistic activity”).

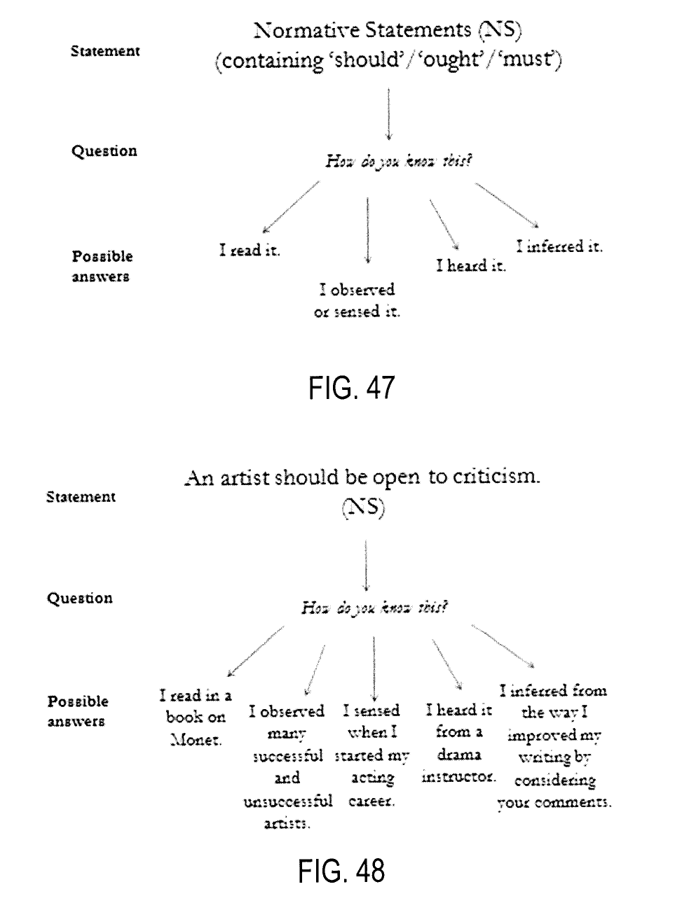

As shown in FIG. 47, the question may be ‘How do you know this?’ or ‘Why do you believe this?’ Users may also ask another user that has inputted a normative statement ‘How do you know this?’ or ‘Why do you believe this?’ regarding that statement. Possible answers to these questions include statements like “I observed it”, “I inferred in from . . . ”, “I heard it in/on . . . ” or “I read it in/on . . . ”.

For example, as shown in FIG. 48, if one user inputs the normative statement ‘an artist should be open to criticism’ and is asked ‘How do you know this?’ or ‘Why do you believe this?’ then he or she may answer by inputting statements such as ‘I inferred it from the way your criticism has improved my writing’, or “I heard it in drama class” or, “I read it in a book on Monet”, and so forth (FIG. 48).

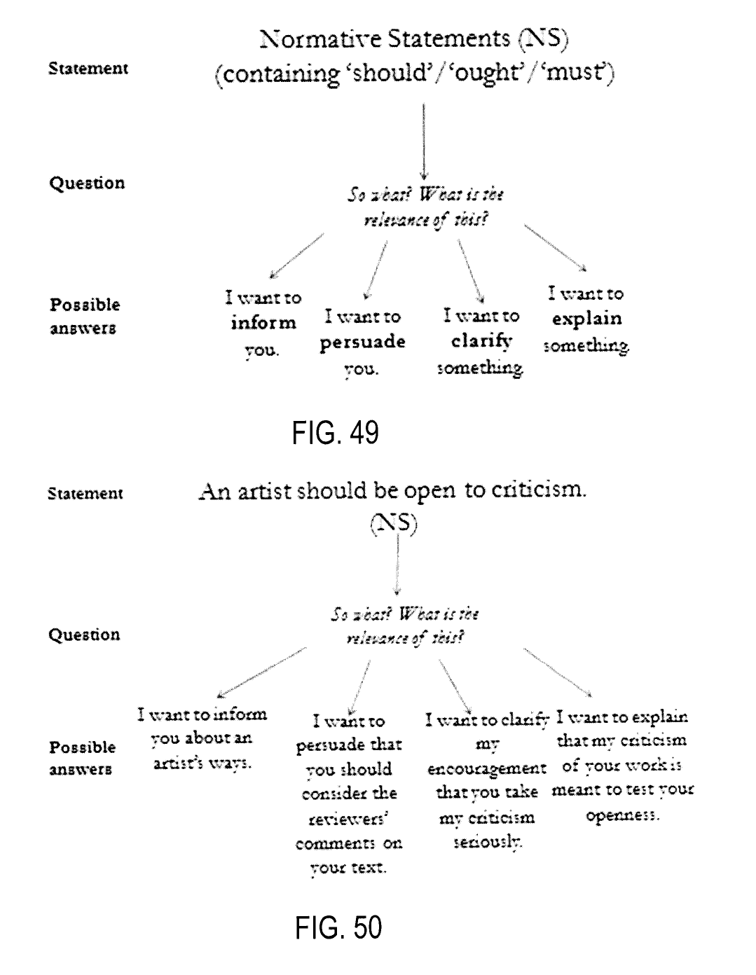

As shown in FIG. 49, the question may be ‘So what? What is the relevance of this?’ Users may also ask ‘So what?’, or, ‘What is the relevance of this?’ about normative statements inputted by other users. As shown, possible answers to ‘So what?’ or, ‘What is the relevance of this?’-type questions may include statements like ‘I want to inform you . . . ’, ‘I want to explain something . . . ’, or ‘I want to clarify something . . . ’.

For example, as shown in FIG. 50, if the statement inputted by one user is ‘an artist should be open to criticism’ and another user asks ‘So what?’ or ‘What is the relevance of this?’, the proponent of the statement may give answers such as (FIG. 50): ‘I want to inform you about an artist's ways of being’, ‘I want to persuade you to accept the reviewers' comments on your text’, ‘I want to explain that my criticism of your work is meant to test your openness’, and so forth.

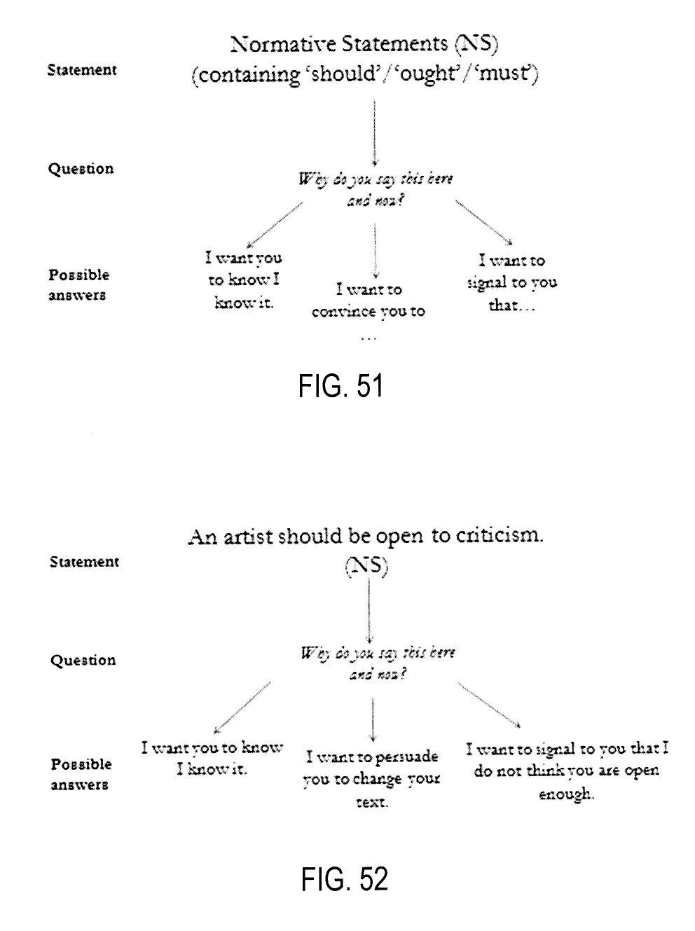

As shown in FIG. 51, the questions may be ‘Why do you say this here and now?’ Users may also ask ‘Why do you say this here and now?’ regarding normative statements that are inputted by other users. This question probes into the immediate intent of the proponent of the statement in putting the statement forth. As shown, possible answers include ‘I want you to know I know it’, ‘I want to convince you to do something’, or ‘I want to signal to you that . . . ’.

For example, as shown in FIG. 52, if a user inputs for the statement ‘An artist should be open to criticism’ and another user asks, ‘Why do you say this here and now?’, the first user may answer, ‘I want you to know I know it’, or, ‘I want to convince you to change your text’, or, ‘I want to signal to you I do not think that you are open enough.’

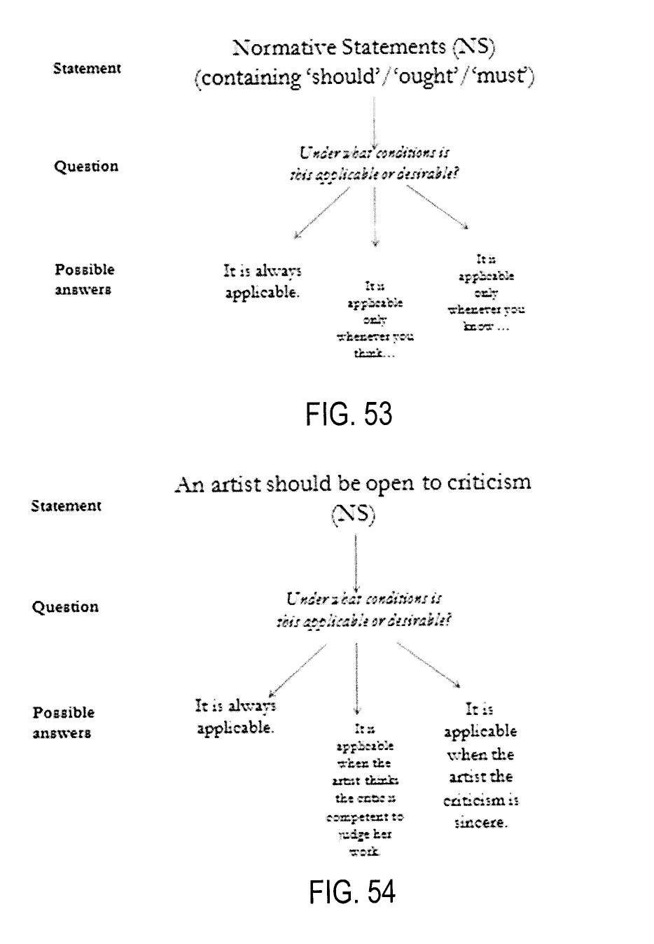

As shown in FIG. 53, the questions may be ‘Under what conditions is this applicable or desirable?’ Because normative statements are most often general or universal in nature—e.g., ‘You should do this/We ought to do that/She must do this’—they can be questioned as to the range of situations or particular instances in which they are supposed to apply. Users may ask ‘Under what conditions is this desirable or applicable?’ of other users who have input normative statements into the interface. As shown, possible answers include ‘It is always applicable’, ‘It is only applicable whenever the artist thinks . . . ’, ‘It is only applicable when the artist knows . . . ’, and so forth.

For example, as shown in FIG. 54, if one user has inputted the normative statement ‘An artist should be open to criticism’ and another user asks ‘Under what conditions is this statement applicable’, the first user may answer ‘It is always applicable’, or, ‘It is only applicable if the artist thinks the criticism is sincerely given’, or, ‘It is only applicable if the artist thinks the critic is competent’, and so forth.

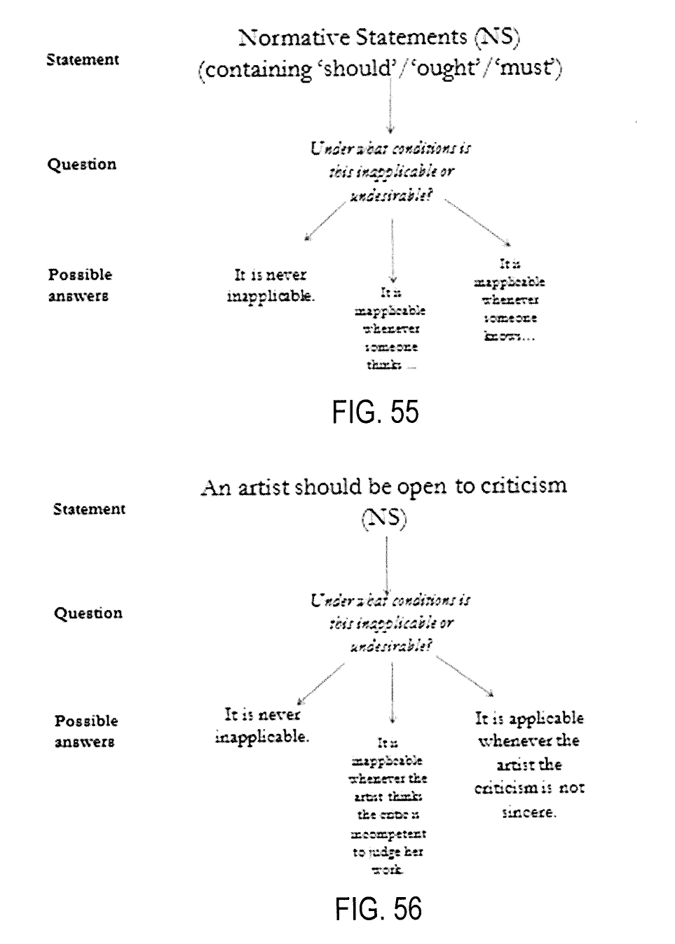

As shown in FIG. 55, the questions may be ‘Under what conditions is this inapplicable or undesirable?’ Just as descriptive general statements can be questioned both with regard to the instances to which they are valid (What is an example of this?) and the instances to which they are not valid (What is a counter-example of this?), so normative statements, because they are often transcendent of the circumstances of time and place of their proponent, can also be questioned both with regard to the instances to which they apply (Under what conditions is this applicable or desirable?) and to the instances to which they do not apply (Under what conditions is this inapplicable or undesirable?) A user may therefore ask another user that has inputted a normative statement for conditions under which the statement is not applicable, or for conditions under which the action it commands or commends is not desirable (Under what conditions is this inapplicable or undesirable?) As shown, possible answers include ‘It is never inapplicable’ (which is logically equivalent to ‘It is always applicable’), or ‘It is inapplicable when someone thinks . . . ’, or ‘It is inapplicable when someone knows . . . ’.

For example, as shown in FIG. 56, if a user inputs the statement ‘an artist should be open to criticism’ and another user asks ‘Under what conditions is this inapplicable or undesirable?’ the first user may answer ‘It is never inapplicable’, or ‘It is inapplicable whenever the artist thinks the critic is incompetent to evaluate her work’, or, ‘It is inapplicable whenever the artist thinks the criticism is insincere’. Note that while the answers ‘It is always applicable’ and ‘It is never inapplicable’ are logically equivalent, the answers ‘It is applicable when the artist thinks the criticism is sincere’ and ‘It is inapplicable when the artist the criticism is insincere’ are not logically equivalent. This is because ‘It is applicable when the artist thinks the criticism is sincere’ does not specify what the artist should do when she thinks the criticism is insincere. In order to do that, the user would have to answer the question ‘Under what conditions is this applicable or desirable?’ by, ‘It is only applicable when the artist thinks the criticism is sincere’, or, even more precisely, ‘It is applicable if and only if the artist thinks the criticism is sincere.’ When platform (100) functions as a ‘dialogical and conversational precision coach’, the logical and grammatical form of the answers may be weighed heavily.

The suggestions may be used by a proponent himself/herself to: modify a statement, clarify a statement, or develop an answer or response. Suggestions may be used by challengers to formulate a query, statement or challenge relevant to a proponent's statement.

Platform (100) may also suggest moves that are challenges. In particular, platform (100) allows users to challenge statements and arguments—or, chains of linked statements—and to respond to these challenges interactively. Platform (100) is configured to allow users to identify the specific statement or argument that they want to challenge, to select from among several different challenge forms, to input challenges that are targeted to different statements and arguments, and to respond to challenges that have been raised against a statement.

In particular, platform (100) allows users wishing to raise a challenge to choose (a) the statement or set of statements that the challenge is addressed to and (b) the specific type of challenge that the user wishes to raise.

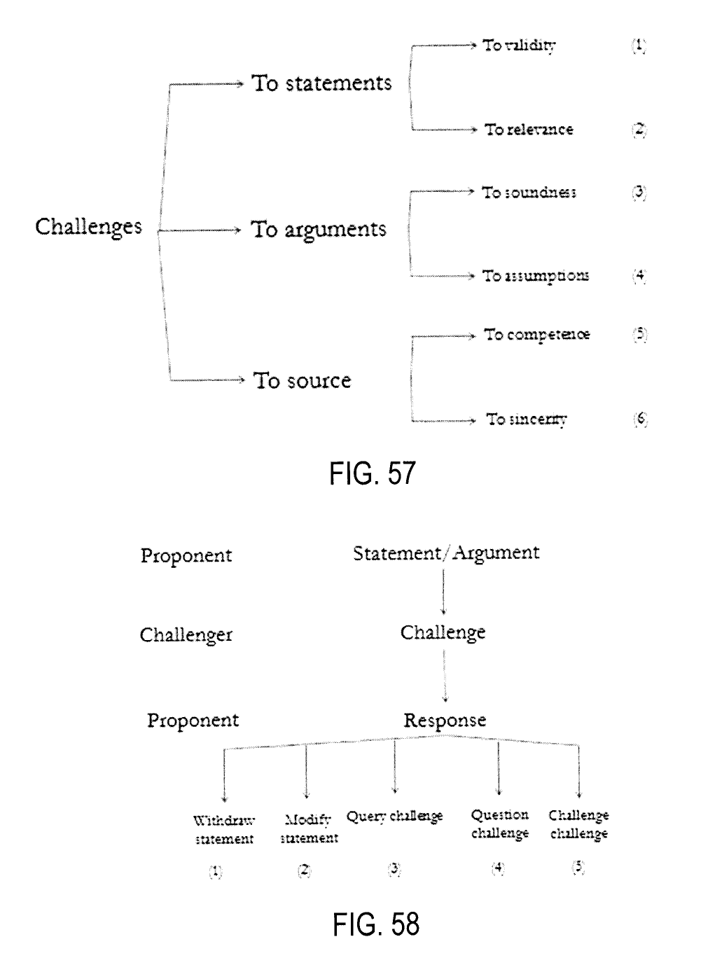

FIG. 57 illustrates the various types (and subtypes) of challenges that may be provided by platform (100):
a) Challenges to statements, including:
b) Challenges to the validity of a statement;
c) Challenges to the relevance of a statement;
d) Challenges to arguments—or, sets of inferentially linked statements, including:
e) Challenges to the soundness of an argument, or, the degree to which and the logic by which statements made in answer to questions about a statement support the statement;
f) Challenges to implicit assumptions, or, to statements that must be antecedently or independently true in order for a statement to be valid.
g) Challenges to sources cited or offered by users in support of the validity of a statement, including:
h) Challenges to the competence of a source, or, to the ability of the source to come to know a statement to be true (or, false);
i) Challenges to the sincerity of a source, or, to the willingness of the source to make a true statement in the case of interest.

Platform (100) also allows users to respond in a structured fashion, and in different ways, to challenges to their statements or arguments made by other users, as shown in FIG. 58. When challenged, a respondent may: (i) withdraw the statement if he or she considers the challenge to be valid; or (ii) query the challenge, asking the challenger to unpack/clarify all or part of the challenge, as shown in FIG. 58.

Unlike questions and queries, challenges are statements, whose validity usually implies that the statement they are meant to challenge is invalid or irrelevant, or that the source of the statement is insincere or incompetent. Therefore, challenges may themselves be questioned and challenged. Accordingly, platform (100) allows respondents to issue challenges to: (i) question the challenger with respect to one or more of the statements that form the substance of the challenge; and (ii) challenge one or more of the challenger's statements, using the entire suite of challenges that the challenger himself has at his or her disposal, also as shown in FIG. 58.

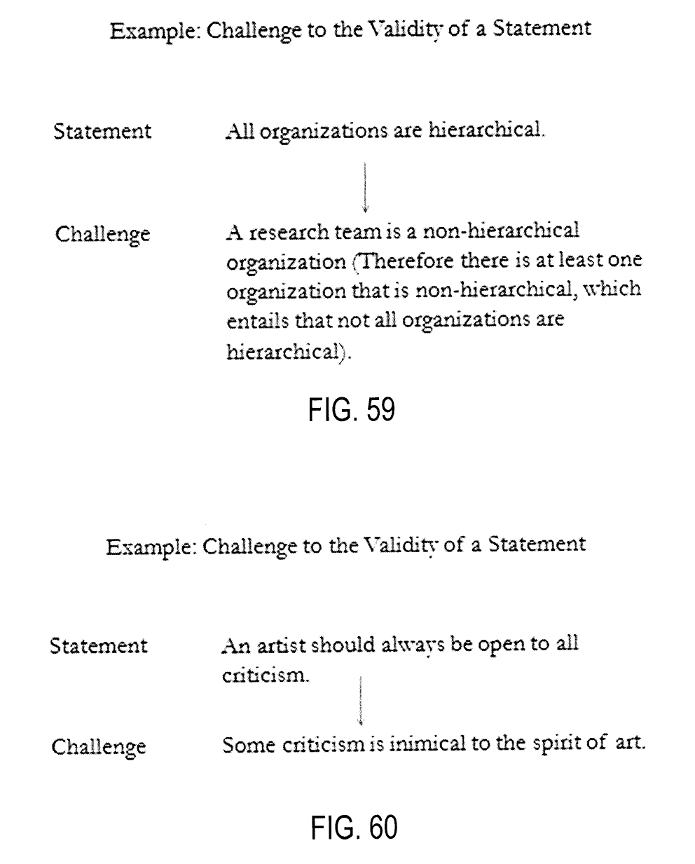

Platform (100) may allow users to challenge statements with respect to their validity. A challenge to the validity of a statement consists of a statement that is believed by the challenger to be true, but which contradicts the statement that the user has put forth. For example, as shown in FIG. 59, if the user inputs the statement ‘all organizations are hierarchical’, then another user can challenge that statement by inputting the statement ‘a group of researchers is a non-hierarchical organization’. This statement entails that there is at least one non-hierarchical organization, which in turn entails that not all organizations are hierarchical, which in turn entails that the statement ‘all organizations are hierarchical’ is not true.

Note that there may be several steps involved in getting a challenge to the point of precision where it explicitly contradicts (challenges) a statement. In many cases, these steps may be implicit, or understood by both the user and the challenger. In other cases, it may be that the use needs to query or question the challenger before arriving at understanding of the fact that the challenge challenges the statement, and of the precise way in which it does so. Therefore, the challenge may be treated as a statement by the user whose statement is challenged, and questioned (but not challenged) before the user needs to respond to it. In the example above, the user may ask ‘so what?’ of the challenging statement ‘a group of researchers is a non-hierarchical organization’. The challenger may answer ‘therefore there is at least one non-hierarchical organization’. The user can ask ‘so what?’ of that statement, and the challenger may answer ‘therefore not all organizations are hierarchical, which entails that the statement ‘all organizations are hierarchical’ is not true’—which clarify the sense in which ‘a group of researchers is a non-hierarchical organization’ contradicts the statement ‘all organizations are hierarchical’.

In another example, as shown in FIG. 60, the statement inputted by the user is ‘an artist should always be open to all criticism’. The challenge inputted by the challenger is ‘some criticism is inimical to the spirit of art’, and challenges the statement because it can be construed as entailing that an artist should not be open to criticism that is inimical to the spirit of art.’ Once again, the user can ask the challenger to ‘unpack’ the challenging statement. For instance, the user may query the challenger with ‘what do you mean by ‘inimical to the spirit of art?’ The user may answer “I mean that it inhibits the very act of creating art”, and then modify the challenging statement to read ‘Some criticism inhibits the very act of creating art”. Of course, the user may still ask “So what?” regarding the modified statement and the challenger may respond “an artist should not listen to criticism that inhibits the very act of creating art”, which does, in fact, directly and explicitly challenge the statement ‘an artist should always be open to all criticism’.

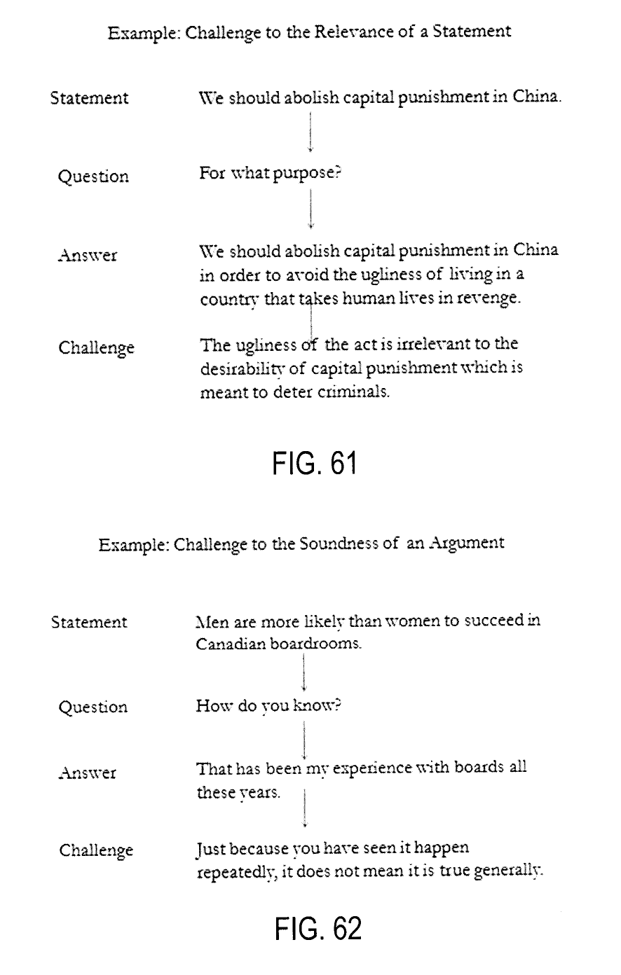

Platform (100) may also allow users to challenge the relevance of each other's statements. Challenges to relevance are almost always challenges of a statement to another statement, and will most often arise in situations in which a user has answered one or more questions about a statement to another user. For example, as shown in FIG. 61, a user may input the normative statement ‘We should abolish capital punishment in China.’ Another user may ask ‘For what purpose?’, and the first user may answer ‘We should abolish capital punishment in China in order to avoid the ugliness of living in a country that takes human lives in revenge.’ The second user may challenge the relevance of the first user's statement by inputting the statement “The ugliness of the act is irrelevant to the durability of capital punishment.’

In yet another example, platform (100) allows users to challenge the soundness of an argument—or, of a set of statements are logically inter-related such that some statements support others. Usually, arguments are presented in the form of syllogisms that make use of standard forms of inference in deductive logic (modus ponens, modus tollens) in order to prove a statement as a logical consequence of another statement. For example, the statements ‘all men are mortal’, ‘Socrates is a man’ and ‘Therefore Socrates is mortal’ are used as an illustration of a valid syllogism, and the argument represented by the statements ‘All men are mortal & Socrates is a man, Therefore Socrates is mortal’ are taken to be a valid argument. By contrast, the argument represented by ‘Some men are mortal’, ‘Socrates is a man’ and ‘Therefore Socrates is mortal’ is not considered to be a valid syllogism—and therefore do not form a sound argument, because the conclusion ‘Socrates is mortal’ does not follow from the premises ‘Some men are mortal’ and ‘Socrates is a man’. Soundness differs therefore from validity: ‘Socrates is mortal’ is valid, but it does not follow from the premises ‘some men are mortal’ and ‘Socrates is a man’ because Socrates may, according to the argument, be one of the men that are not mortal.

Platform (100) may extend the notion of an argument to informal statements, and considers an argument to be a chain of statements that are taken by the user to lend support to one another. For example, as shown in FIG. 62, a user may input the statement ‘men are more likely than women to succeed in Canadian boardrooms’. A second user questions the statement via, ‘How do you know?’. The first user answers ‘That has been my experience so far.’ Taken together, the two statements input by the first user can be understood as forming an argument as follows: “I know that men are more likely to succeed than women in Canadian boardrooms (statement 1) because I have seen more men than women succeed in my experience with boards (statement 2).” It can be challenged with regards to its soundness,—i.e. with respect to whether or not the second statement supports the first statement. The second user can enter the challenge, ‘Just because you have seen it happen repeatedly, it does not mean that it is true generally.’ The challenge here is not to the validity of the statement (which may be true, independently of the experience of the user) or to the validity of the answer that the user gives in response to the question ‘How do you know?’—as the user may have indeed experienced boards in which men are more likely to be successful than women. The challenge is to the degree to which the statement ‘That has been my experience so far’ lends support to the statement ‘Men are more likely than women to succeed in Canadian boardrooms.’

Platform (100) may also allow users to challenge each other's arguments with respect to the implicit assumptions which one would have to believe in order to accept the argument as valid or sound. For example, suppose one user enters the statement ‘The sun will rise tomorrow?’ The second user asks: ‘How do you know?’ The first user answers: ‘I know it will rise because I have seen it rise for 10,000 consecutive days.’ The second user can challenge the inferential link between the first user's answer and the first user's statement by stating: “You only know that the sub will rise tomorrow based on your experience if you know that past experience is a reliable indicator of future outcomes, which is not always true.’ This is the assumption on which the inferential link between the first user's answer to the question about his statement and the first user's statement is predicated. If this assumption is false, then the link is invalid.

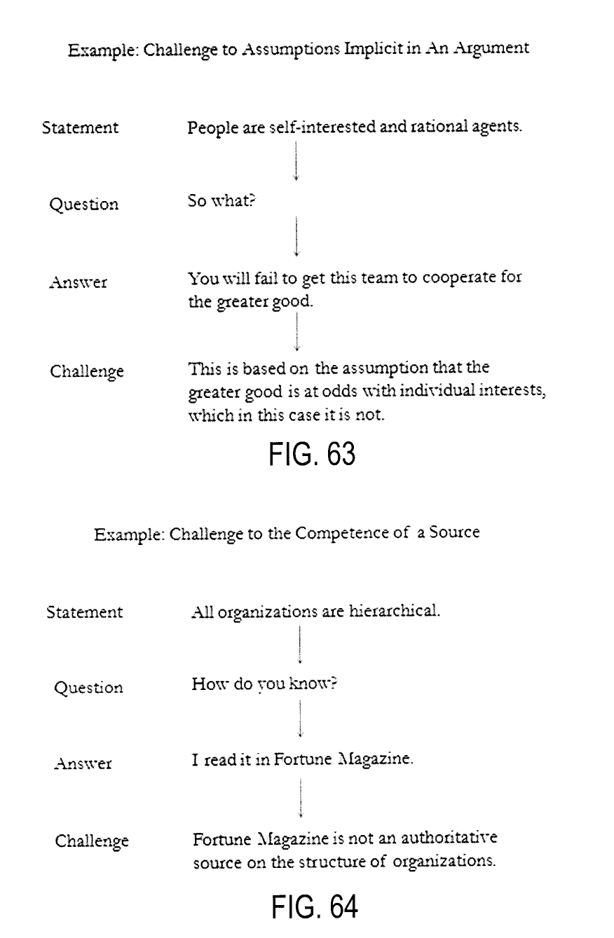

In another example, as shown in FIG. 63, the first user inputs the statement ‘People are self-interested and rational’, and the second user asks ‘So what?’ the first user answers ‘You will not be able to get the people on this team to cooperate for the greater good.’ The second user can challenge this statement by inputting the challenge ‘This is based on the assumption that the greater good is at odds with individual interests, which in this case it is not.’

Platform (100) may also allow users to challenge the source of a statement, or of an answer to a question about a statement, with respect to the competence of the source to know or form a valid belief about the statement in question. For example, if one user says ‘It will rain tomorrow’ another user asks ‘How do you know?’ and the first user answers ‘because the weather forecaster on China Daily News said so’, the second user may challenge the source (the weather forester) by saying: ‘That forecaster has been wrong 99 times out of the last 100 in predicting the weather.’

In another example, as shown in FIG. 64, the first user inputs the statement ‘all organizations are hierarchical’. The second user asks ‘How do you know?’ the first user answers ‘I read it in Fortune Magazine’. The second user then can challenge with ‘Fortune magazine is not an authoritative source on the structure of organizations.’

Platform (100) may also allow users to challenge a source with respect to its sincerity, or, its motivation to assert the truth, or, more severely, to assert the truth, the whole truth and nothing but the truth.

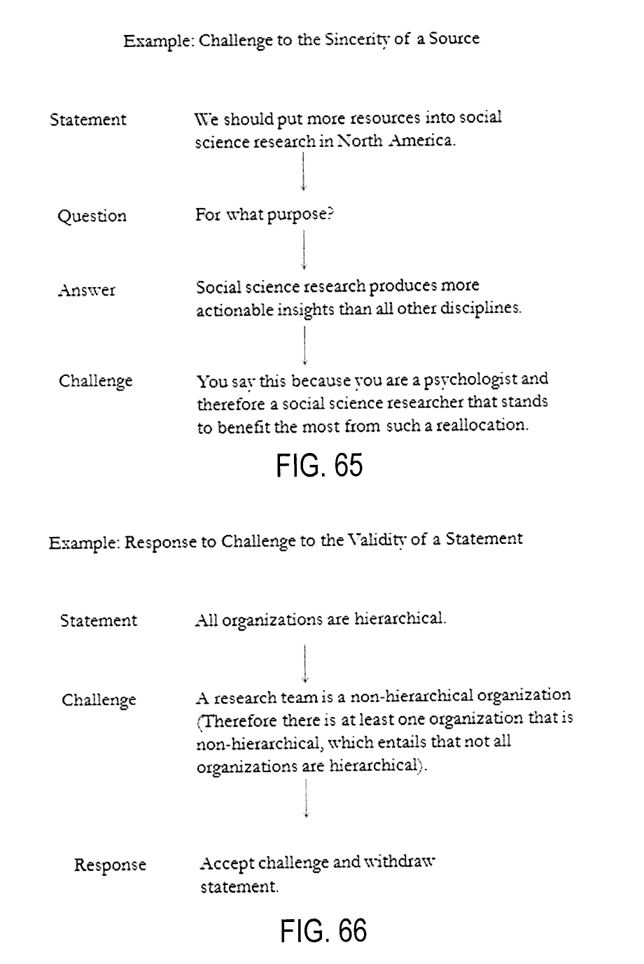

For example, as shown in FIG. 65, the first user may input the statement ‘we should put more resources into social science research in North America’. The second user may ask ‘For what purpose?’ The first user may answer ‘Social science research produces more actionable insights than any other discipline’. The second user can challenge the sincerity of the first user by inputting the statement ‘You say this because you are a psychologist, and therefore one of the researchers that stands to benefit from such a re-allocation.’

As noted, platform (100) allows users to respond to challenges to their statements, or to their answers to questions about their statements. In particular, users may be allowed to respond in one of several ways, as follows.

Platform (100) may allow users to withdraw the statement as a result of the challenge, if they believe that the challenge is valid and that its validity negates that of the statement. For example, as shown in FIG. 66, if the first user inputs the statement ‘all organizations are hierarchical’ and the second user challenges it by inputting the challenge ‘a research team is a non-hierarchical organization’—which entails that there is at least one non-hierarchical organization, which further entails that it is not true that all organizations are hierarchical, then the first user can withdraw the statement as posed.

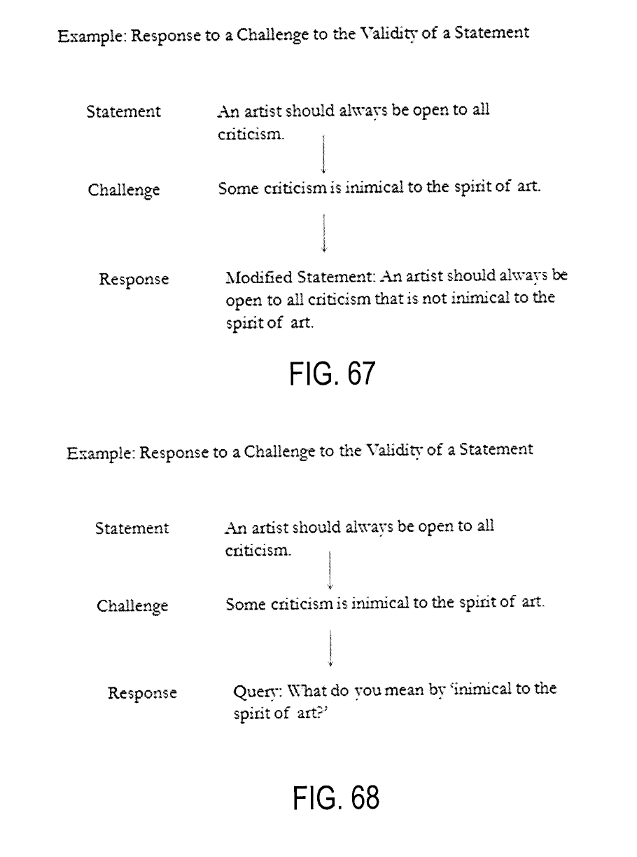

Platform (100) may also allow users to modify their statement or answer to a question about a statement, or argument, in response to a challenge raised by other users. For example, as shown in FIG. 67, if the first user inputs the statement ‘an artist should always be open to all criticism’ and the second user inputs the challenge ‘some criticism is inimical to the spirit of art’, then the first user can modify the statement ‘an artist should always be open to all criticism’ and input the modified statement ‘an artist should always be open to all criticism that is not inimical to the spirit of art’.

Platform (100) may also allow users to query the challenger regarding the meaning of words or phrases that appear in the challenge. For example, as shown in FIG. 68, if the first user inputs the statement ‘an artist should always be open to all criticism’ and the second user inputs the challenge ‘some criticism is inimical to the spirit of art’, then the first user can query the challenger by asking ‘what do you mean by ‘inimical to the spirit of art?’

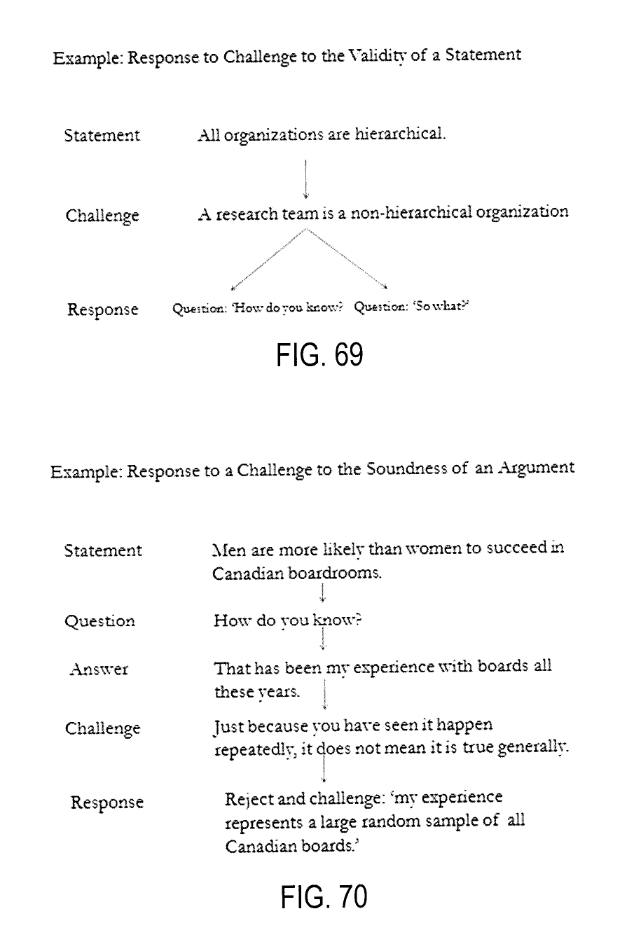

Platform (100) may also allow users to question a challenge that is raised to a statement, an answer to a question about a statement, or an argument. For example, as shown in FIG. 69, if the first user inputs the statement ‘all organizations are hierarchical’ and the second user challenges the statement by inputting the statement ‘a team of research scientists is a non-hierarchical organization’, then the first user can ask ‘so what?’, or, ‘how do you know?’

Platform (100) may also allow users to challenge a challenger's challenge. They may only do so, however, after having first rejected the challenge. A challenge to a challenge, then, represents the reason for a user's rejection of a challenge. For example, as shown in FIG. 70, if the first user inputs the statement ‘men are more likely than women to succeed in Canadian boardrooms’, the second user asks ‘how do you know?’, the first user answers ‘that has been my experience with boards all these years’ and the second user challenges with ‘just because you have seen it happen repeatedly, it does not mean it is true generally’, the first user can first reject the challenge and then challenge the challenge by inputting the statement ‘my experience represents a large scale random sample of all Canadian boards (and therefore it is a good indicator of what is true of all Canadian boards).’

### Training

Embodiments of the communication platform disclosed herein may be used as a dialogical training tool. When configured and operated for such purpose, embodiments may be isolate, train and enhance the ability and propensity of its users to:
a) Make their statements clear and precise and query their own and others' statements in order to make them clear and precise;
b) Question their own and other users' statements of fact and value with respect to the validity, reliability and relevance of the statement and with respect to the motivation of the proponent of the statement;
c) Evaluate, modify, track and evaluate the validity of the inferences that they and other users make
d) Answer questions about their own beliefs, opinions, judgments and assertions in a way that is connected to the question, informative to the questioner and responsive to the intent of the questioner in asking the question;
e) Build well-constructed, logically coherent and semantically consistent arguments (chains of statements linked by deductive, inductive or other inferences) and evaluate their own and others' arguments;
f) Modify their statements and arguments in response to valid questions;
g) Use targeted questioning protocols to audit the base of assumptions and implications of their own and others' statements;
h) Challenge their own statements and arguments in a structured way with respect to the validity, coherence and reliability of the statement, and with respect to the competence and sincerity of the proponent of the statement;
i) Respond to challenges, and, if warranted, modify or abandon their original statements.

### General

While the disclosure provides certain details regarding one or more computer program aspects of the present invention, the functions of the computer program are explained without limiting the application to the invention to any particular computer program architecture. Each functional component may be implemented as part of a computer program module with multiple functions, or may be implemented as including one or more other functional components. A skilled reader will understand that numerous possible implementations are contemplated.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Although the disclosure has been described and illustrated in exemplary forms with a certain degree of particularity, it is noted that the description and illustrations have been made by way of example only. Numerous changes in the details of construction and combination and arrangement of parts and steps may be made. Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations and modifications are possible, and even advantageous, in various circumstances. The invention is intended to encompass all such variations and modification within its scope, as defined by the claims.

1. A system for guiding communication by users engaging in dialogue, the system comprising:
one or more computers executing a server application that provides:
a semantic analyzer component configured to analyze at least part of a dialogue to produce content analysis data, and
(ii) a communication facilitator component configured to:
select at least one discourse rule from a plurality of discourse rules;
apply the discourse rules to the content analysis data, and
provide at least one suggestion to a user engaging in the dialogue;
wherein the user utilizes the at least one suggestion by selecting or adapting a statement based on the at least one suggestion, and wherein utilizing the at least one suggestion promotes, in an automated fashion, the use of validated dialogical strategies in the dialogue.

2. The system of claim 1, wherein the server application provides a scoring component configured to generate a score for at least a portion of the dialogue based on dialogical performance.

3. The system of claim 2, wherein the score is generated for a particular statement, a particular user, or a particular dialogue.

4. The system of claim 1, wherein the at least one suggestion comprises a question responsive to the analyzed part of the dialogue.

5. The system of claim 1, further comprising a network interface, and wherein the server application is configured to receive the at least part of the dialogue by way of the network interface.

6. The system of claim 1, wherein the user is a first user, and the server application provides an observer component configured to allow a second user to observe progression of the dialogue.

7. The system of claim 6, wherein the observer component is configured to allow the second user to provide feedback to the first user.

8. The system of claim 6, wherein the observer component is configured to allow the second user to provide a score for the first user.

9. The system of claim 1, wherein the semantic analyzer component is configured to identify a statement type of the at least part of a dialogue.

10. The system of claim 1, wherein the communication facilitator component is configured to provide suggestions to at least two users engaging in the dialogue.

11. A computer-implemented method for guiding communication by users engaging in dialogue, the method comprising:
receiving, at at least one processor, at least part of a dialogue from a user;
analyzing, at the at least one processor, the received part of the dialogue to produce content analysis data;
selecting, at the at least one processor, at least one discourse rule from a plurality of discourse rules stored in an electronic datastore;
applying, at the least one processor the selected at least one discourse rules to the content analysis data, and
generating, at the at least one processor, at least one suggestion to a user engaging in the dialogue.

12. The method of claim 11, wherein said receiving is by way of a data network.

13. The method of claim 11, wherein said portion of the dialogue is received by way of a social media platform.

14. The method of claim 11, wherein said portion of the dialogue is received by way of a plugin for a software comprising at least one of a web browser, a word processor, a document viewer, and an instant messaging software.

15. The method of claim 14, wherein said portion of the dialogue comprises text presented in said software.

16. The method of claim 11, wherein the at least one suggestion comprises a question responsive to the received part of the dialogue.

17. The method of claim 11, further comprising scoring at least a portion of the dialogue on the basis of dialogical performance.

18. The method of claim 11, wherein said analyzing comprises identifying a statement type of the received part of the dialogue.

19. The method of claim 11, further comprising storing records of the dialogue engaged in by the user in an electronic datastore.

20. The method of claim 19, further comprising modifying the plurality of discourse rules based on the stored records.

21. The method of claim 11, wherein the user is a first user, and the method further comprises receiving another part of the dialogue from a second user.

22. The method of claim 21, further comprising repeating the analyzing, selecting, applying, and generating for the part of the dialogue received from the second user.
